(19) United States
(12) Patent Application Publication
(10) Pub. No.: US 2026/0355880 A1
(43) Pub. Date: Nov. 12, 2026

(54) TOOL REPLACING ARM

(71) Applicant: FANU CCORPORATION, Minamitsuru-gun,Yamanashi (JP)

(72) Inventor: Gaku ISOBE, Minamitsuru-gun, Yamanashi (JP)

(73) Assignee: FANU CCORPORATION, Minamitsuru-gun,Yamanashi (JP)

(21) Appl. No.: 19/487,377

(22) PCT Filed: Jun. 8, 2023
(86) PCT No.: PCT/JP2023/021432

§ 371 Date: Nov. 24, 2025

(51) Int. Cl. B23Q 3/155

(52) U.S. Cl. CPC B23Q 3/1554; B23Q 2003/155414

(57) ABSTRACT

The purpose of the present invention is to suppress sliding when a gripping member collides with a stopping surface. This tool replacing arm replaces a tool used by a work machine. The tool replacing arm comprises an arm base and a plurality of gripping members. Each gripping member is rotatably attached to the arm base and, through rotation, grips the tool or releases such grip. The arm base is provided with a stopping surface that limits the rotation range of the gripping member as a result of abutting against the gripping member at a position that blocks the rotation of the gripping member. On a virtual plane which includes the entire rotational axis of the gripping member, the stopping surface extends along the virtual member.

### TECHNICAL FIELD

The present disclosure relates to a tool changing arm that replaces tools used by a machine tool.

### BACKGROUND ART

Some tool changing arms include an arm base and a plurality of gripping members. The plurality of gripping members are rotatably attached to the arm base, respectively, and grip and release the tools by the rotation.

### CITATION LIST

### Patent Document

Patent Document 1: Japanese Unexamined Patent Application, Publication No. 2020-192678

### DISCLOSURE OF THE INVENTION

### Problems to be Solved by the Invention

The present inventors have conceived of adopting the following configuration for such a tool changing arm. The arm base is provided with abutting surfaces each of which restricts the range of rotation of a corresponding one of the plurality of gripping members by coming into contact with the corresponding one at a position that prevents rotation.

However, the present inventors have focused on the fact that the following issues may occur in such a tool changer. Each of the gripping members repeats the collision with the abutting surface by repeating the rotation toward the side of gripping the tool and the rotation toward the side of releasing the gripping. At the time of the collision, the gripping member slightly slides with respect to the abutting surface, whereby wear of the abutting surface and the grip member progresses. This wear may cause malfunction of the tool changing arm.

The present disclosure has been made in view of the above circumstances, and an object thereof is to suppress sliding when a gripping member collides with an abutting surface.

### Means for Solving the Problems

The present disclosure is directed to a tool changing arm that replaces a tool used by a machine tool, the tool changing arm including: an arm base; and a plurality of gripping members rotatably attached to the arm base and each configured to grip and release the tool by rotation, wherein the arm base includes an abutting surface that limits a rotation range of one of the plurality of gripping members by the abutting surface coming into contact with the one of the plurality of gripping members at a position that prevents the one of the plurality of gripping members from rotating, and the abutting surface extends, on a virtual plane including an entire rotation axis of one of the plurality of gripping members, along the virtual plane.

### BRIEF DESCRIPTION OF THE DRAWINGS

FIG. 1 is a perspective view showing a tool changer of the present embodiment;

FIG. 2 is a view of the tool changer viewed in the Y+ direction;

FIG. 3 is a view of an arm and its surroundings as viewed in the Y+ direction;

FIG. 4 is a perspective view showing a magazine;

FIG. 5 is a side view of a fixing member as viewed in the X+ direction;

FIG. 6 is a cross-sectional view of the magazine as viewed in the Y+ direction;

FIG. 7 is an exploded perspective view showing a tool pot;

FIG. 8 is a cross-sectional view of the pot body as viewed in the X− direction, specifically, a cross-sectional view taken along the line FIG. 8-FIG. 8 indicated in FIG. 7;

FIG. 9 is a cross-sectional view of a state in which the clamp mechanism is attached to the pot body, as viewed in the X− direction;

FIG. 10 is a cross-sectional view of a state in which a posture holding member is further attached to the pot main body, as viewed in the X− direction;

FIG. 11 is a cross-sectional view of a state in which the tool is held in the tool pot, as viewed in the X− direction;

FIG. 12 is a view of the pot main body as viewed in the Y+ direction;

FIG. 13 is a cross-sectional view of an arm swiveling device as viewed in the Y+ direction;

FIG. 14 is an exploded perspective view showing a swiveling axial member and an arm base;

FIG. 15 is a cross-sectional view of a lower portion of the swiveling axial member and the arm base as viewed in the Y+ direction;

FIG. 16 is a perspective view showing an arm;

FIG. 17 is a view of the arm viewed in the Y+ direction;

FIG. 18 is a top view of the arm;

FIG. 19 is a view of the arm and a spindle-side cam Cs viewed in the Y+ direction;

FIG. 20 is a perspective view showing a first gripping member 77 and the surroundings thereof;

FIG. 21 is a view of the first gripping member 77 and its surroundings as viewed in the Y+ direction;

FIG. 22 is a cross-sectional view of the first gripping member 77 and the first base member as viewed in the Y+ direction, specifically, a cross-sectional view taken along the line FIG. 22-FIG. 22 indicated in FIG. 18;

FIG. 23 is a cross-sectional view of the first gripping member 77 and the first base member viewed in the Y+ direction in the comparative example;

FIG. 24 is a view showing an initial state of tool replacement by the tool changer;

FIG. 25 is a diagram showing the next state;

FIG. 26 is a diagram showing the next state;

FIG. 27 is a diagram showing the next state;

FIG. 28 is a diagram showing the next state;

FIG. 29 is a diagram showing the next state;

FIG. 30 is a diagram showing the next state;

FIG. 31 is a diagram showing the next state;

FIG. 32 is a diagram showing the next state;

FIG. 33 is a diagram showing the next state.

FIG. 34 is a perspective view showing a tool pot according to a second embodiment;

FIG. 35 is a cross-sectional view of the tool pot as viewed in the X− direction, specifically, a cross-sectional view taken along the line FIG. 35-FIG. 35 indicated in FIG. 34;

FIG. 36 is a cross-sectional view of a state in the middle of holding the tool in the tool pot as viewed in the X− direction;

FIG. 37 is a cross-sectional view of a state in which the tool is held in the tool pot as viewed in the X− direction;

FIG. 38 is a cross-sectional view of the tool pot as viewed from below, specifically, a cross-sectional view taken along the line FIG. 38-FIG. 38 indicated in FIG. 37;

FIG. 39 is a perspective view showing a piece; and

FIG. 40 is a perspective view showing another example of a piece.

### PREFERRED MODE FOR CARRYING OUT THE INVENTION

Hereinafter, embodiments of the present disclosure will be described with reference to the drawings. However, the present disclosure is not limited to the following embodiments in any way, and can be appropriately modified and implemented without departing from the gist of the present disclosure.

### First Embodiment

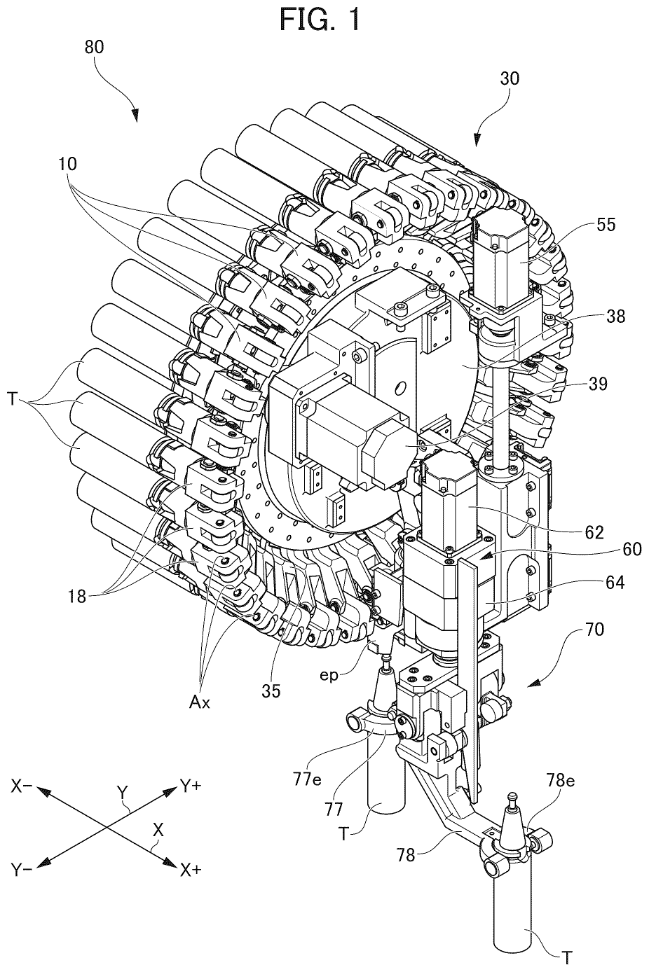

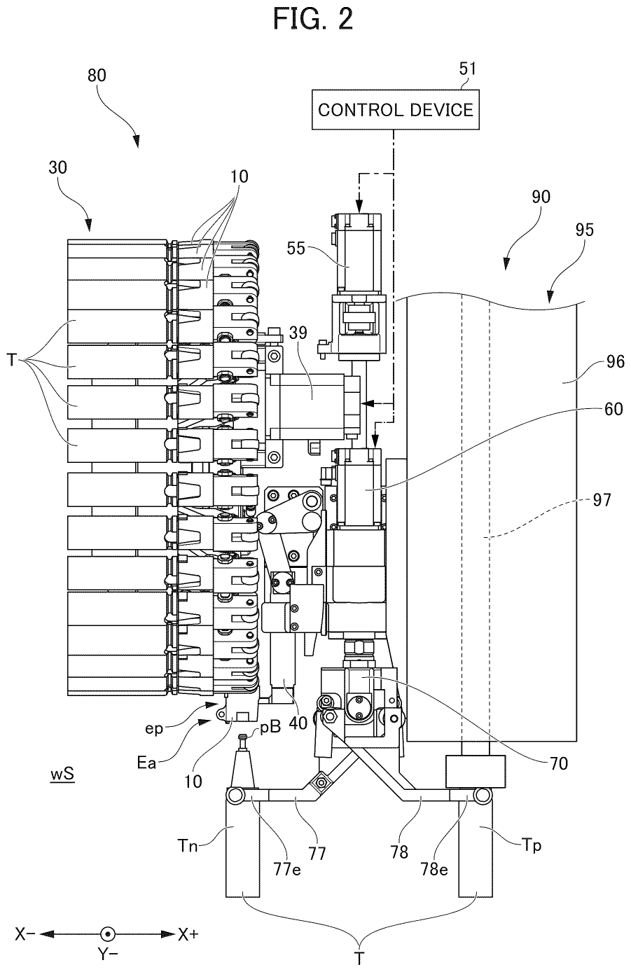

A tool changer 80 shown in FIG. 1 is provided in a machine tool 90 as shown in FIG. 2. Hereinafter, as shown in FIG. 1, two predetermined directions orthogonal to each other in a horizontal plane are referred to as an “X direction” and a “Y direction”. Further, one side in the X directions is referred to as “X− direction”, and the opposite direction is referred to as “X+ direction”. In addition, one side in the Y directions is referred to as a “Y− direction”, and the opposite direction is referred to as a “Y+ direction”.

As shown in FIG. 2, the machine tool 90 includes a spindle assembly 95. The spindle assembly 95 includes a spindle 97 and a housing 96. The spindle 97 is provided so that the axial length direction thereof accords with the up-down direction. The housing 96 covers the spindle 97. The spindle assembly 95 is configured to move up and down.

A base end portion of one of the plurality of tools T is attached to a lower end portion of the spindle 97. A pull stud bolt pB is provided at a base end portion of each tool T. Hereinafter, a tool T that has been attached to the spindle 97 up to now among the plurality of tools T is referred to as a “previously-used tool Tp”, and a tool T to be attached to the spindle 97 next among the plurality of tools T is referred to as a “subsequently-used tool Tn”.

As shown in FIG. 2, the tool changer 80 includes a control device 51, and includes a magazine 30, a magazine swiveling device 39, an arm 70, an arm swiveling device 60, an arm elevating device 55, and a pot drive mechanism 40 in a machine interior space wS of the machine tool 90. The “magazine 30” may also be referred to as a “tool magazine,” and the arm 70 may also be referred to as a “tool changing arm”.

The magazine 30 and the spindle assembly 95 are provided side by side in the X direction, and specifically, the spindle assembly 95 is provided on the X+ direction side of the magazine 30. The arm swiveling device 60 is provided between the magazine 30 and the spindle assembly 95. The pot drive mechanism 40 is provided between the magazine 30 and the arm swiveling device 60. The arm 70 is provided below the arm swiveling device 60. The arm elevating device 55 is provided above the arm swiveling device 60.

First, the magazine 30 shown in FIG. 1 will be described. The magazine 30 includes a magazine base 38, a swivel member 35 and a plurality of tool pots 10. The swivel member 35 is attached to the magazine base 38 in a swiveling manner about the X direction. The magazine swiveling device 39 is attached to the magazine base 38. The magazine swiveling device 39 includes an actuator such as a motor. The magazine swiveling device 39 causes the swivel member 35 to rotate relative to the magazine base 38 about the X direction.

The plurality of tool pots 10 are attached to the swivel member 35 side by side in the swiveling direction. Therefore, one of the plurality of tool pots 10 is provided at the “replacement position ep” as the lowest standby position for tool replacement by the rotation of the swivel member 35.

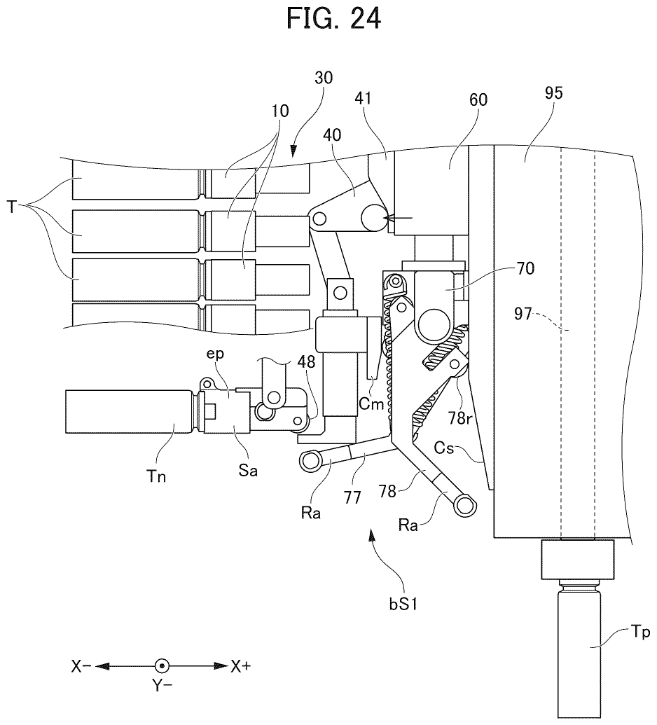

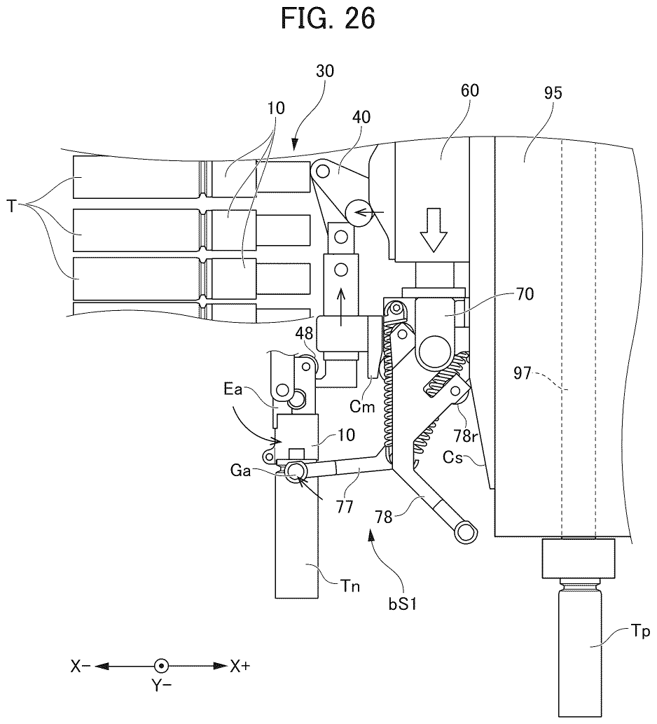

The tool pot 10 at the replacement position ep rotates between the replacement angle Ea shown in FIG. 26 and the storage angle Sa shown in FIG. 24 by rotation about the Y direction as an axis. The replacement angle Ea shown in FIG. 26 is an angle at which the held tool T can be replaced, specifically, an angle at which the tool pot 10 stands in the up-down direction. On the other hand, the storage angle Sa shown in FIG. 24 is an angle at which the held tool T is stored, specifically, an angle at which the tool pot 10 falls down in the X direction.

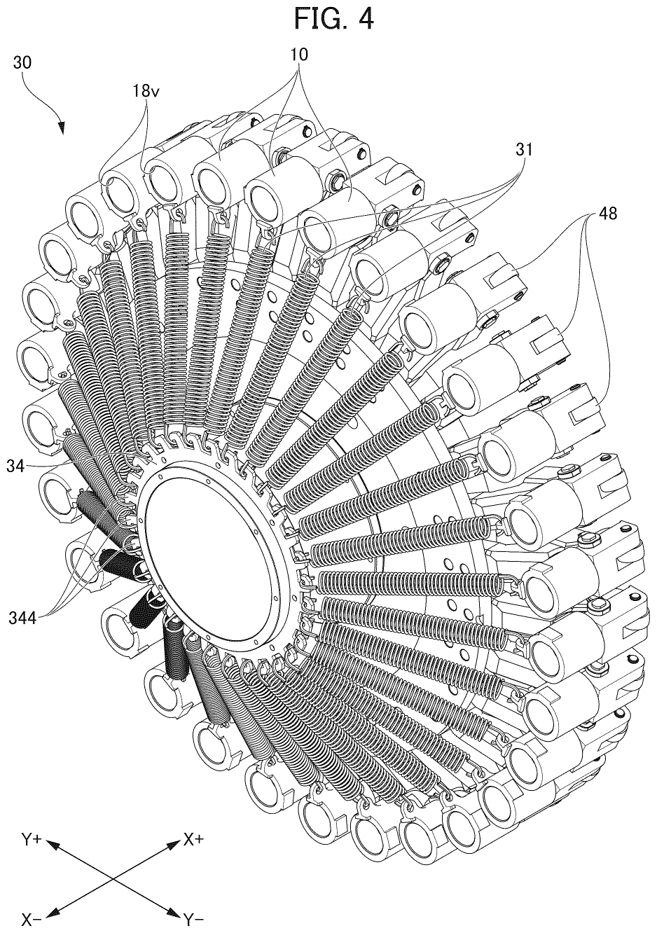

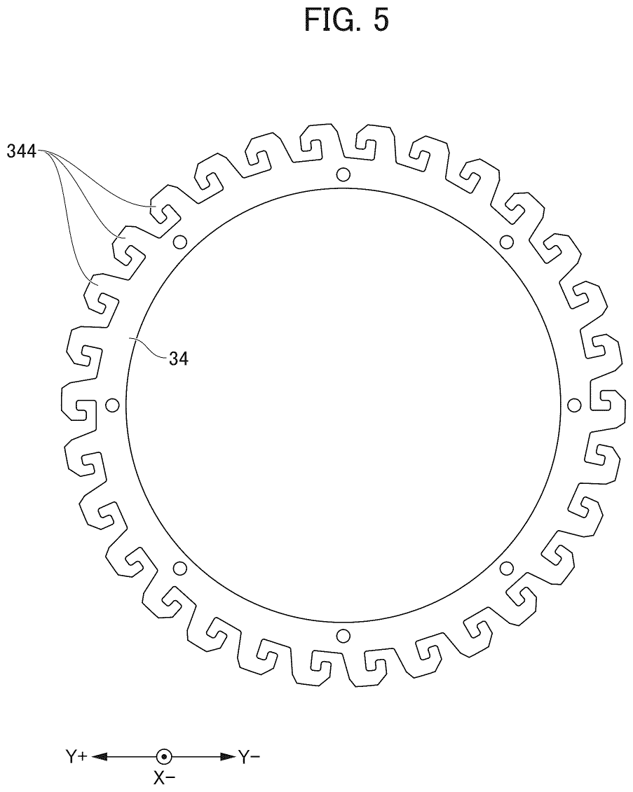

As shown in FIG. 4, the magazine 30 further includes a plurality of biasing members 31 and a fixing member 34. A corresponding biasing member 31 is provided for each tool pot 10. The fixing member 34 is a metal member fixed to the swivel member 35. The fixing member 34 extends annularly in the swiveling direction of the swivel member 35. In the fixing member 34, support portions 344 are provided side by side in the swiveling direction of the swivel member 35. A corresponding support portion 344 is provided for each tool pot 10. As shown in FIG. 5, each support portion 344 has a key shape engageable with an end portion of a corresponding one of the biasing members 31.

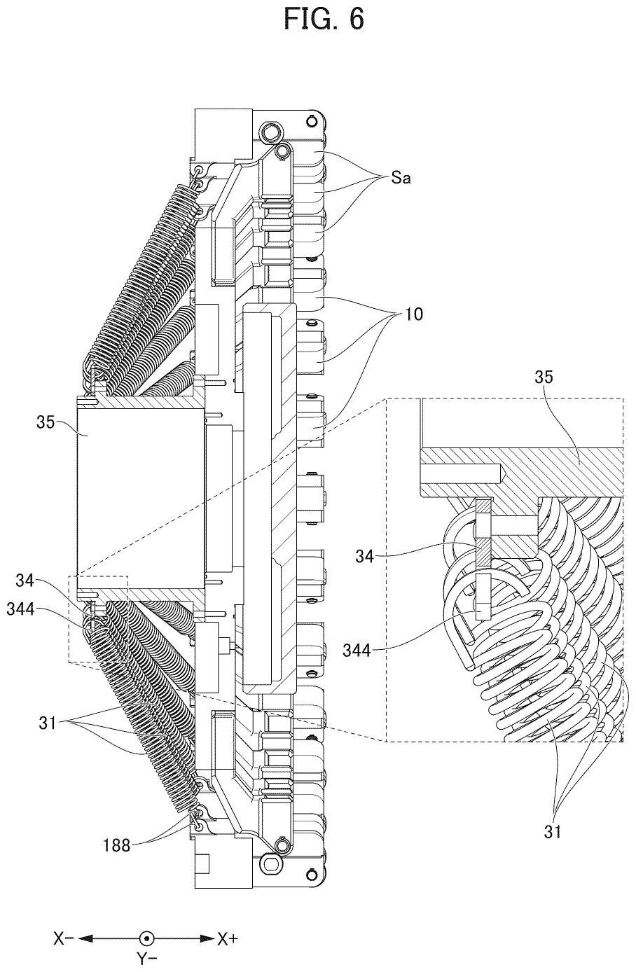

As shown in FIG. 6, one end portion of each of the biasing members 31 is attached to a corresponding one of the pot bodies 18 by being inserted into an engagement hole 188 (described later) of the corresponding one of the tool pots 10. The other end portion of each of the biasing members 31 is attached to a corresponding one of the support portions 344 of the corresponding one of the tool pots 10. As shown in FIG. 4, each biasing member 31 thereby biases the corresponding tool pot 10 toward the storage angle Sa.

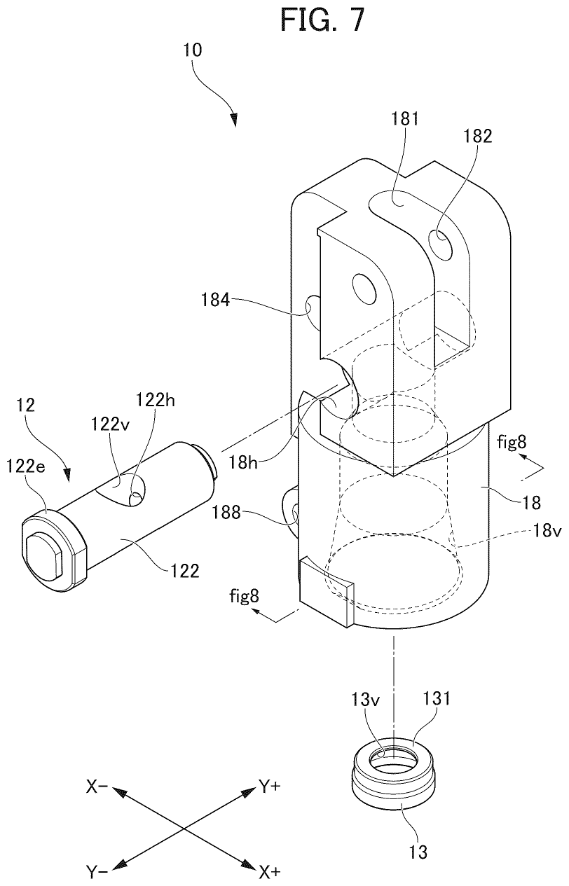

As shown in FIG. 7, each tool pot 10 includes a pot body 18, a clamp mechanism 12, and a posture holding member 13.

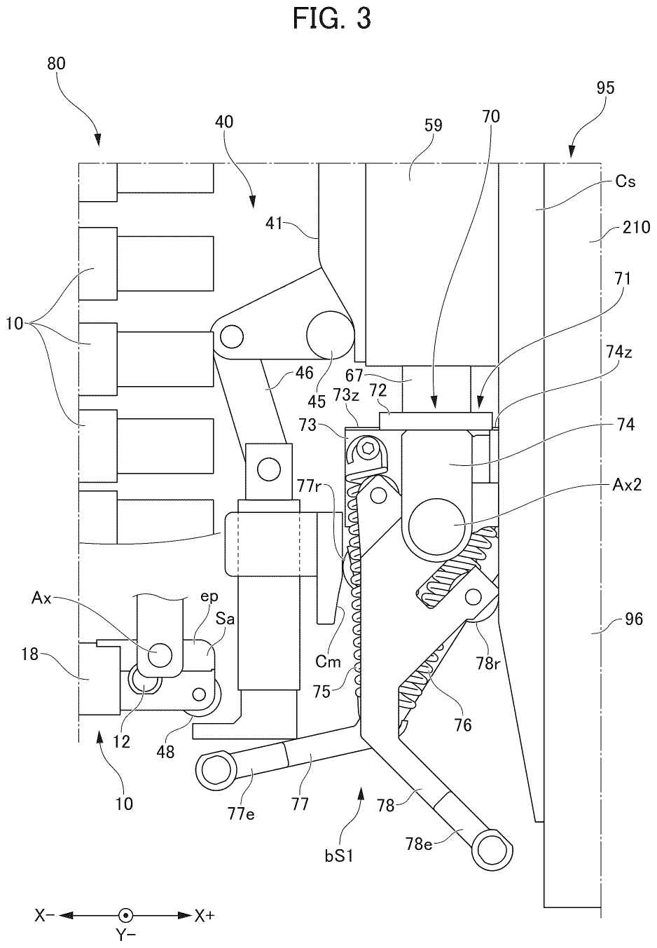

Each pot body 18 is made of resin. As shown in FIG. 1, each pot body 18 is rotatably attached to the swivel member 35 about an axial member Ax extending in a tangential direction of the swiveling direction of the swivel member 35. Therefore, the tool pot 10 at the replacement position ep shown in FIG. 3 is rotatable about the Y direction.

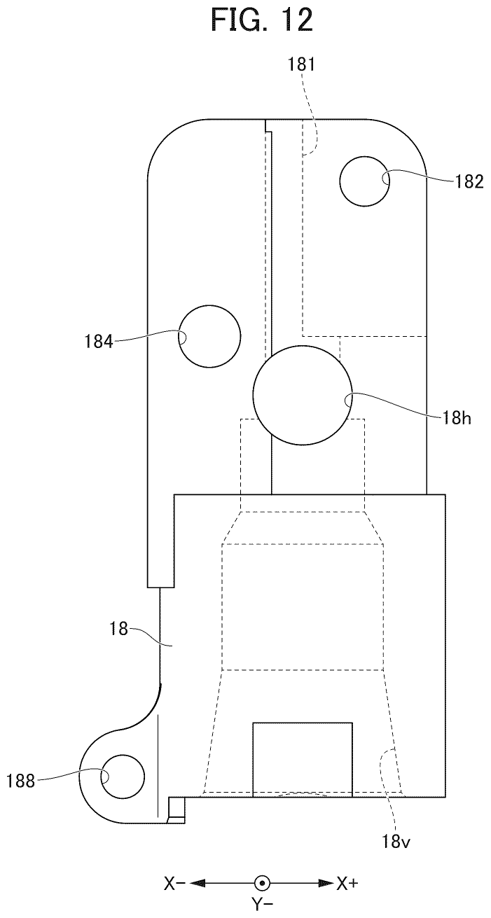

As shown in FIG. 7, a recess 181 for attaching a pot roller 48 described later is provided in an upper portion of the pot body 18. Further, as shown in FIG. 12, the pot body 18 is provided with a roller hole 182, an axis hole 184, and an engagement hole 188. The roller hole 182 is a hole for attaching an axial member that rotatably supports a pot roller 48 described later. The axis hole 184 is a hole for attaching the axial member Ax described above. As described above, one end portion of each of the biasing members 31 is inserted into a corresponding one of the engagement holes 188.

The tool pot 10 is configured as follows viewed in a state of being provided at the replacement angle Ea at the replacement position ep shown in FIG. 2.

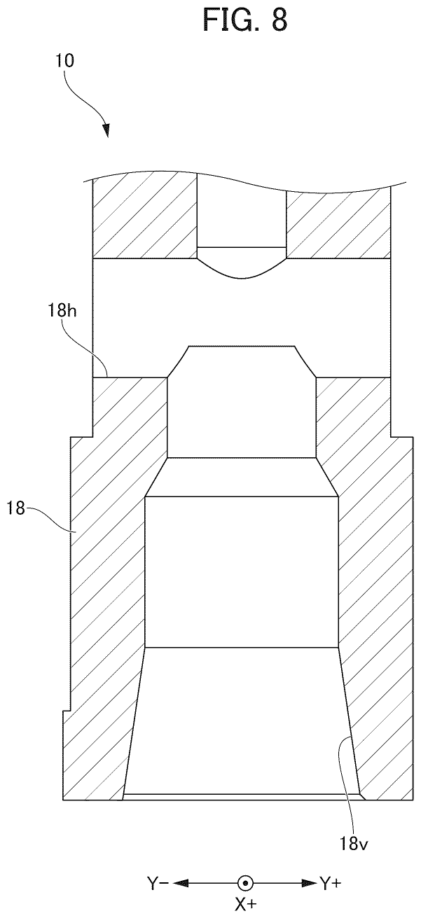

As shown in FIG. 7, in each of the pot bodies 18, an insertion hole 18v into which the pull stud bolt pB of the tool T is insertable extends upward from the lower end of the pot body 18. Therefore, the pot body 18 has a cylindrical shape that opens downward. As shown in FIG. 8, a clamp attachment hole 18h extending in the Y direction and intersecting with the insertion hole 18v is provided in the upper portion of the pot body 18.

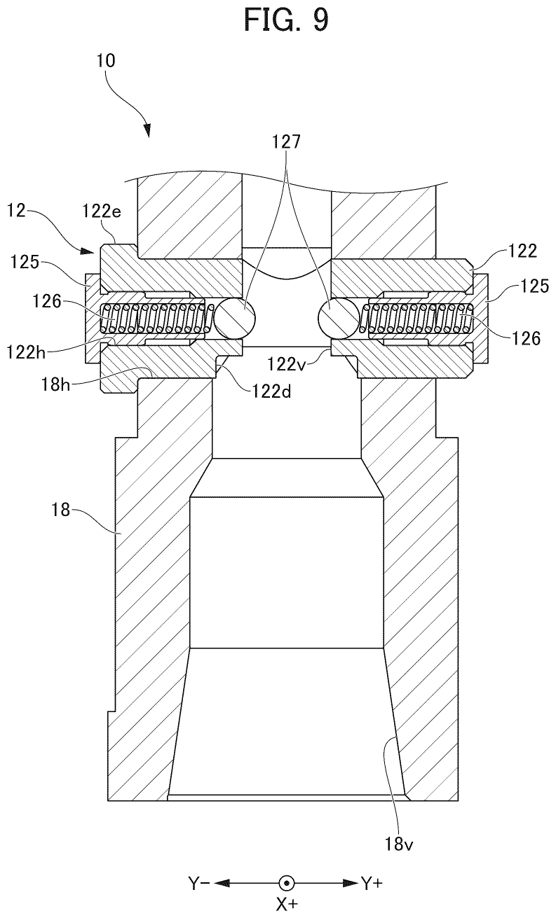

As shown in FIG. 9, the clamp mechanism 12 includes a clamp base 122, a pair of contact members 127, and a pair of biasing members 126. The clamp base 122 is a metal member. Each biasing member 126 is a metal pressing spring. Each contact member 127 is a metal ball. Thus, the clamp mechanism 12 is made of metal.

As shown in FIG. 7, the clamp base 122 extends in the Y direction, and a cylindrical hole 122h extending in the Y direction is provided inside the clamp base 122. Thus, the clamp base 122 is cylindrical. A clamp hole 122v that passes through the clamp base 122 in the up-down direction and intersects with the cylindrical hole 122h is provided in the center of the clamp base 122 in the Y direction. A head 122e protruding more outward in the radial direction of the clamp base 122 than other portions is provided at an end portion of the clamp base 122 on the Y+ direction side.

As shown in FIG. 9, the clamp base 122 is attached to the pot body 18 by being inserted into the clamp attachment hole 18h in the Y+ direction.

The pair of contact members 127 is provided in the cylindrical hole 122h. Specifically, the contact member 127 on the Y− side is provided to be displaceable in the Y direction on the Y− side of the axial center of the clamp hole 122v. On the other hand, the contact member 127 on the Y+ side is provided to be displaceable in the Y direction on the Y+ side of the axial center of the clamp hole 122v.

The pair of biasing members 126 are provided in a portion of the cylindrical hole 122h located outside the pair of contact members 127 in the Y direction. Retainers 125 for holding the outer ends of the pair of biasing members 126 in the Y direction are attached to both ends of the clamp base 122 in the Y direction. Therefore, each biasing member 126 is interposed between the retainer 125 and the contact member 127, and biases the contact member 127 inward in the Y direction. That is, the biasing member 126 on the Y− side biases the contact member 127 on the Y− side in the Y+ direction, and the biasing member 126 on the Y+ side biases the contact member 127 on the Y+ side in the Y− direction.

An engagement recess 122d recessed upward is provided at a portion of the clamp base 122 including the lower end portion of the clamp hole 122v and the surroundings thereof.

The posture holding member 13 shown in FIG. 7 is a metal member and is placed by insertion in the insertion hole 18v of the pot body 18. An insertion through hole 13v is provided in the posture holding member 13. A protrusion 131 protruding upward is provided at a portion adjacent to the inner peripheral side of the posture holding member 13, that is, a portion adjacent to the insertion through hole 13v.

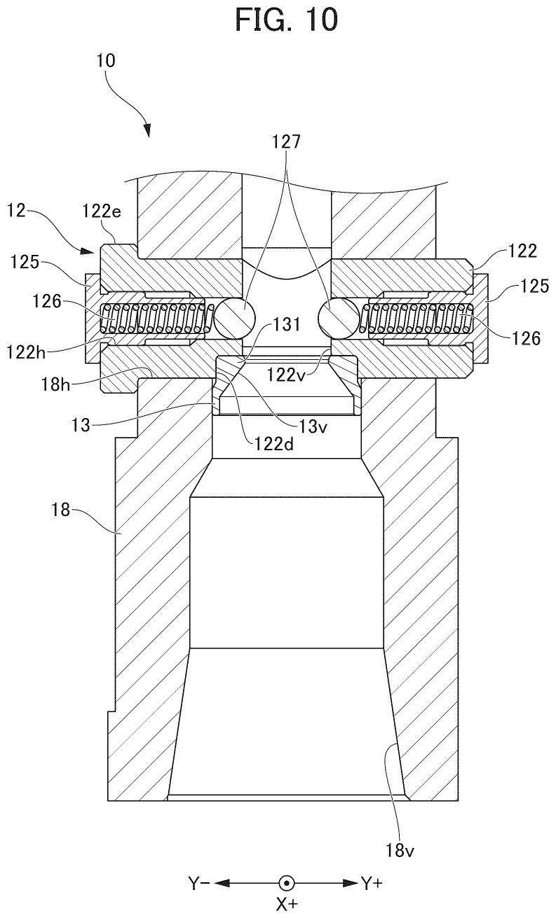

As shown in FIG. 10, the projection 131 of the posture holding member 13 engages with the engagement recess 122d of the clamp base 122 by press-fitting or the like. Accordingly, the clamp mechanism 12 is positioned relative to the pot body 18 in the length direction of the clamp attachment hole 18h, that is, the Y direction, and the circumferential direction of the clamp attachment hole 18h. As a result, the posture of the clamp mechanism 12 relative to the pot body 18 is held. The insertion through hole 13v of the posture holding member 13 is a hole through which the pull stud bolt pB passes to the clamp mechanism 12 when the pull stud bolt pB is inserted into the insertion hole 18v of the pot body 18. The insertion through hole 13v has a tapered shape having a decreasing diameter as approaching the upper side, that is, as approaching the clamp mechanism 12. Thus, the insertion through hole 13v is configured to guide the pull stud bolt pB to the clamp hole 122v of the clamp mechanism 12.

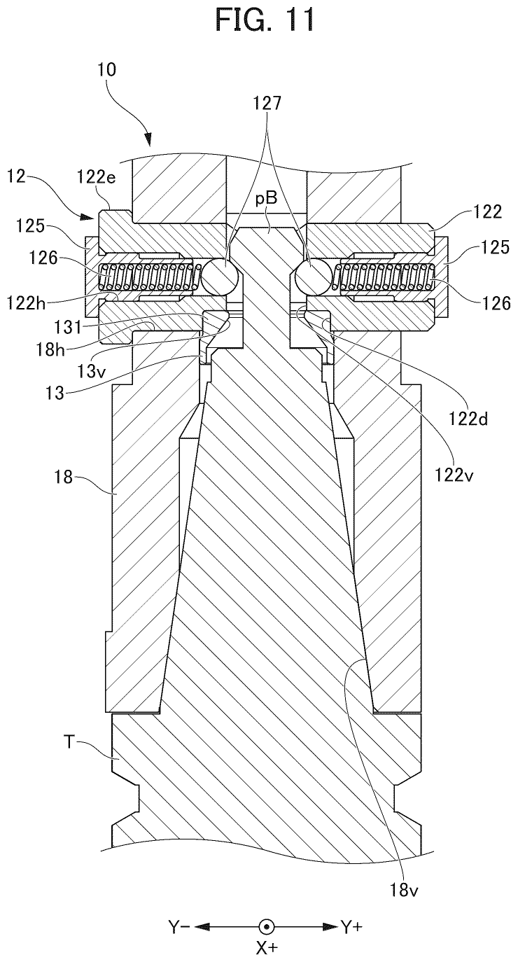

When the pull stud bolt pB is inserted into the clamp hole 122v shown in FIG. 10, the pair of contact members 127 is temporarily pushed outward in the Y direction by the pull stud bolt pB, and then, as shown in FIG. 11, the pair of contact members 127 returns inward in the Y direction. As a result, the pair of contact members 127 holds the pull stud bolt pB from the outside in the Y direction.

Note that, as described above, the above description is a description of the state in which the tool pot 10 is provided at the replacement angle Ea at the replacement position ep shown in FIG. 2.

Next, the arm elevating device 55 shown in FIG. 2 will be described. The arm elevating device 55 includes an actuator such as a motor. The arm elevating device 55 lifts and lowers the arm swiveling device 60 and the arm 70 by lifting and lowering the arm swiveling device 60 to which the arm 70 is attached. Hereinafter, the uppermost point in the drive range of the arm 70 by the arm elevating device 55 is referred to as an “arm uppermost point”, and the lowermost point in the drive range is referred to as an “arm lowermost point”.

Next, the pot drive mechanism 40 shown in FIG. 2 will be described. As shown in FIG. 3, the pot drive mechanism 40 includes a pot drive cam 41, a link roller 45, a link mechanism 46, and a pot roller 48.

The pot drive cam 41 is attached to the arm swiveling device 60 and moves up and down together with the arm swiveling device 60 and the arm 70. The link roller 45 is attached to an upper end portion of the link mechanism 46. As shown in FIG. 3, when viewed in a state in which the tool pot 10 is provided at the storage angle Sa at the replacement position ep, the pot roller 48 is attached to a lower portion of an end portion in the X+ direction of the pot body 18 so as to be rotatable about the Y direction. When the lower end portion of the link mechanism 46 pushes up the pot roller 48, the tool pot 10 rotates toward the replacement angle Ea against the biasing force of the biasing member 31. The link roller 45 is biased toward the pot drive cam 41 by the weight of the link mechanism 46 and the biasing force of the biasing member 31.

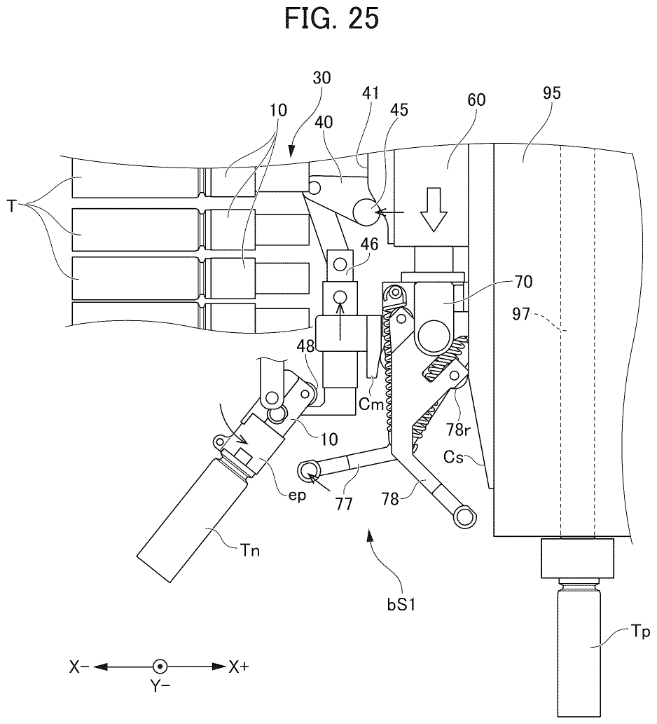

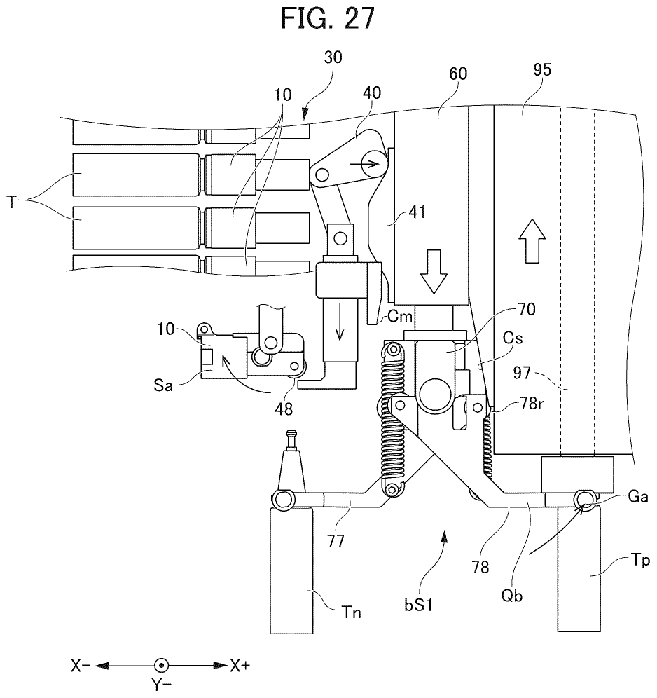

At the time of lowering the arm 70 from the arm uppermost point shown in FIG. 24, first, as shown in FIG. 25, the lower end portion of the link mechanism 46 rises following the profile of the lower portion of the pot drive cam 41, and pushes up the pot roller 48. As a result, as shown in FIG. 26, the tool pot 10 rotates to the replacement angle Ea against the biasing force of the biasing member 31. Thereafter, as shown in FIG. 27, the lower end portion of the link mechanism 46 is lowered following the profile of the upper portion of the pot drive cam 41, and the tool pot 10 is rotated to the storage angle Sa.

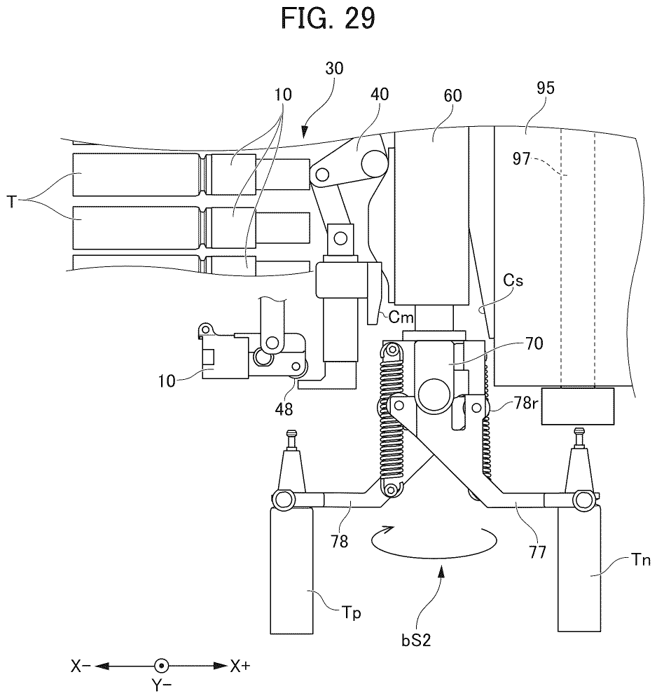

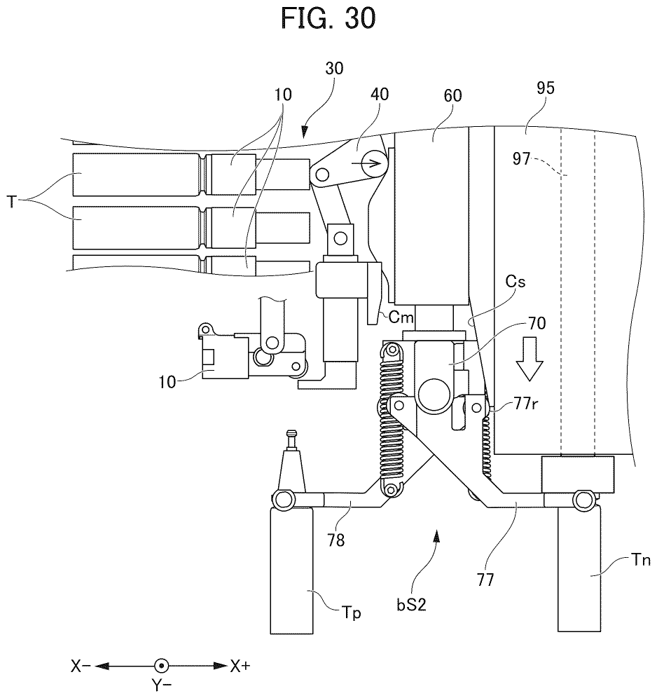

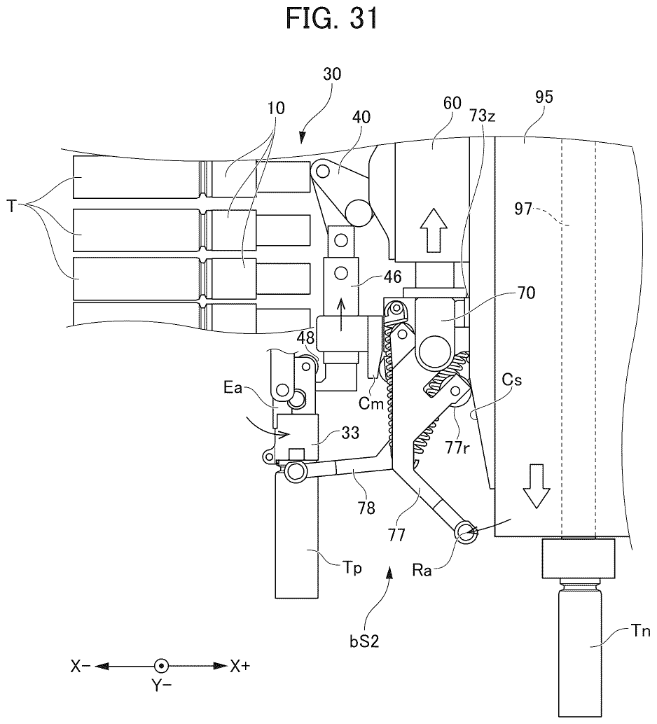

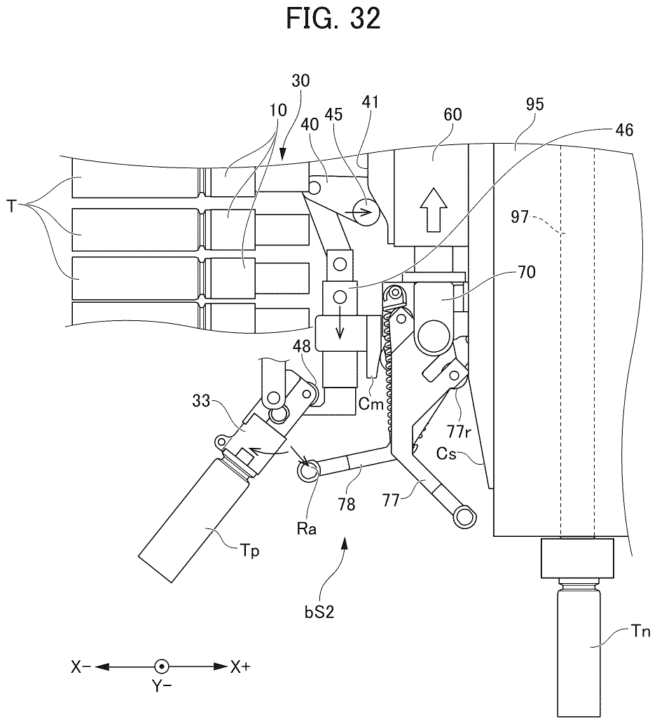

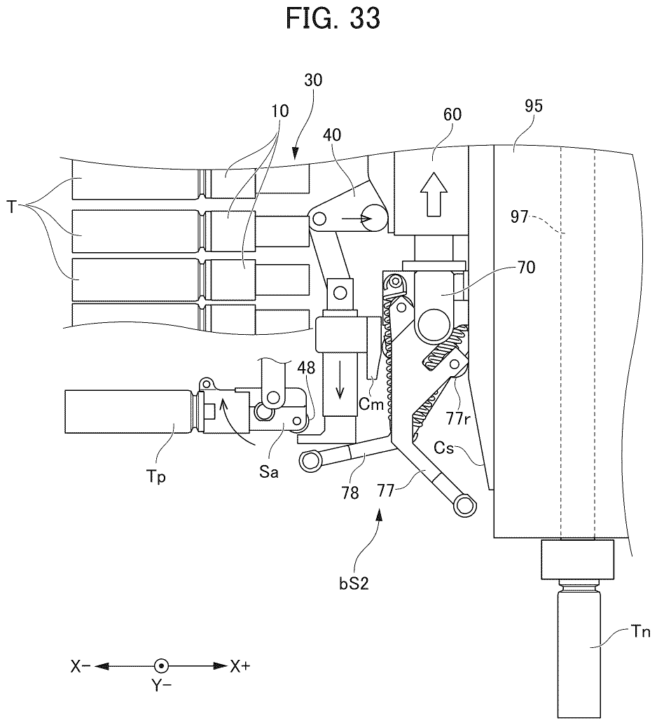

On the other hand, when the arm 70 rises from the lowest point of the arm shown in FIG. 29, first, as shown in FIGS. 30 and 31, the lower end portion of the link mechanism 46 rises following the profile of the upper portion of the pot drive cam 41, and pushes up the pot roller 48. As a result, the tool pot 10 rotates toward the replacement angle Ea against the biasing force of the biasing member 31. Thereafter, as shown in FIGS. 32 and 33, the lower end portion of the link mechanism 46 is lowered following the profile of the lower portion of the pot drive cam 41, and the tool pot 10 is rotated to the storage angle Sa.

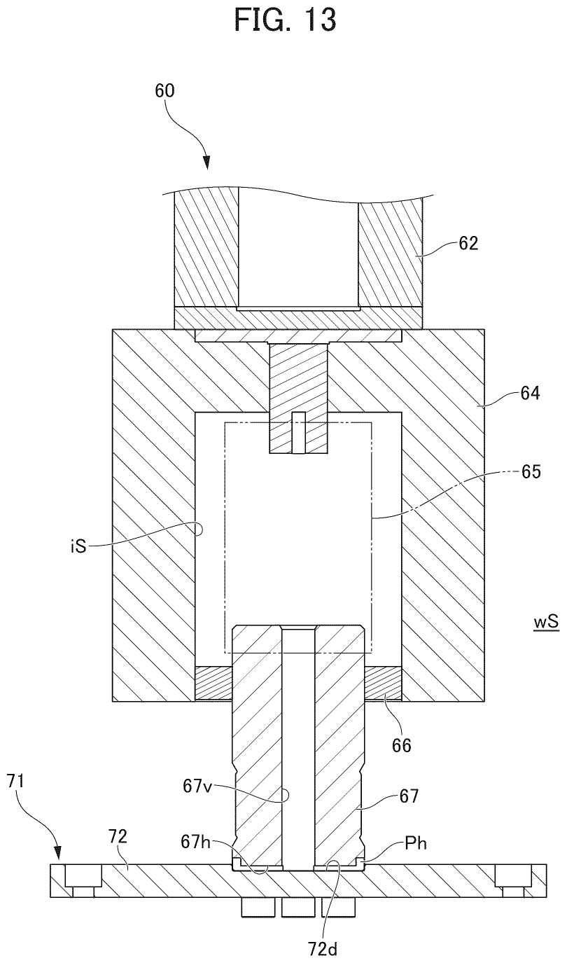

Next, the arm swiveling device 60 shown in FIG. 2 will be described. As shown in FIG. 13, the arm swiveling device 60 includes a drive source 62, a housing 64, a gear reduction device 65, a seal member 66, and a swiveling axial member 67.

The drive source 62 is an actuator such as a motor. The housing 64 has a cylindrical shape that is open in the up-down direction. An internal space is is provided inside the housing 64. The speed reducer 65 is stored in the internal space is. The upper opening of the housing 64 is closed by the drive source 62. The swiveling axial member 67 is provided below the speed reducer 65. The drive source 62 rotates the swiveling axial member 67 via the speed reducer 65. The seal member 66 closes the opening on the lower side of the housing 64 while allowing the swiveling axial member 67 to pass therethrough in the up-down direction. A base plate 72 which is a part of an arm base 71 which is a part of the arm 70 is fixed to a lower end portion of the swiveling axial member 67. Therefore, the arm 70 swivels about the up-down direction together with the swiveling axial member 67.

Next, problems to be solved in the arm swiveling device 60 of the present embodiment will be described. There are cases where the cutting fluid or the like scatters as mist to a portion located outside the housing 64 of the machine interior space wS. Further, when the drive source 62 is running and the speed reducer 65 operates, the outside air may be slightly suctioned into the internal space is of the housing 64 through a gap between the seal member 66 and the swiveling axial member 67. As a result, the atomized cutting fluid may enter the internal space is from the outside. In this case, the cutting fluid that has once entered the internal space is is unlikely to be discharged to the outside. Therefore, by the cutting fluid continuing to remain in the internal space is, the speed reducer 65 may corrode, which adversely affects the speed reducer 65.

On the other hand, in a case where a path connecting the internal space is and the outside of the housing 64 is simply provided to extract the cutting fluid accumulated in the internal space is, there is a risk that the atomized cutting fluid floating outside may enter the internal space together with the gas from this path.

In order to solve the above problems, as shown in FIG. 13, a through hole 67v is provided in the swiveling axial member 67, and a communication path Ph is provided between the swiveling axial member 67 and the base plate 72. The internal space is communicates with the outside of the housing 64 through the through hole 67v and the communication path Ph.

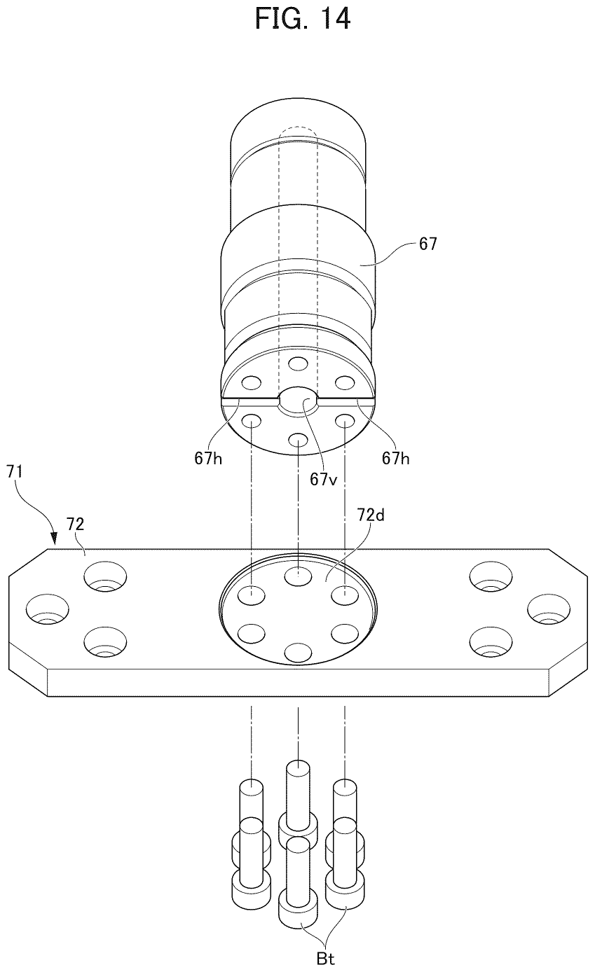

Specifically, the through hole 67v penetrates the swiveling axial member 67 in the up-down direction. Therefore, the upper end portion of the through hole 67v communicates with the internal space iS. As shown in FIG. 14, communication grooves 67h extending from the lower end portion of the through hole 67v to the outer peripheral surface of the swiveling axial member 67 are provided on the lower surface of the swiveling axial member 67. Although two communication grooves 67h are provided in the present embodiment, one communication groove or three or more communication grooves may be provided.

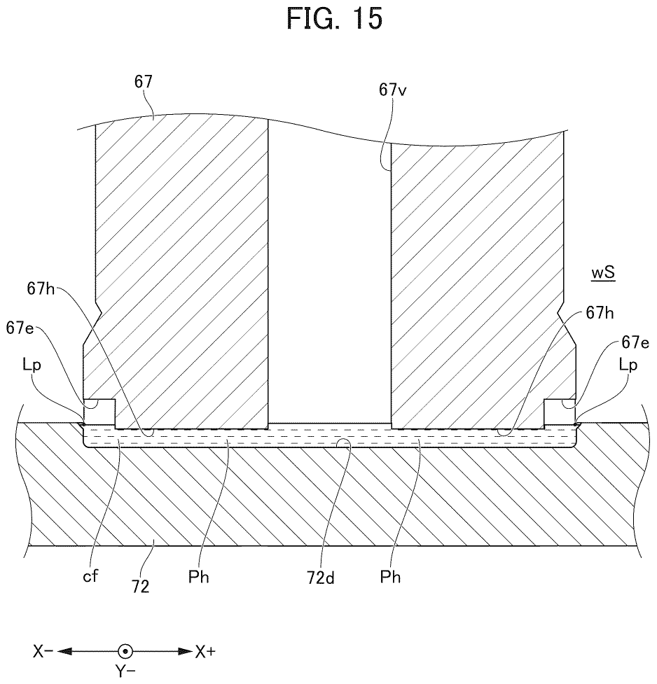

An engagement recess 72d is provided in the upper surface of the base plate 72. The lower end portion of the swiveling axial member 67 is engaged with the engagement recess 72d. Further, by bolts Bt or the like, the base plate 72 is fixed to the lower end portion of the swiveling axial member 67. As a result, as shown in FIG. 15, the communication path Ph is provided inside the inner walls of the communication grooves 67h. The depth of the engagement recess 72d in the up-down direction is deeper than the depth of the communication groove 67h in the up-down direction. An upward extending portion 67e that extends upward from a ceiling surface of an end portion of the communication groove 67h on the outer peripheral surface side of the swiveling axial member 67 and opens to the outside is provided on the outer peripheral portion of the swiveling axial member 67. The inner side of the inner wall of the upward extending portion 67e is also a part of the communication path Ph. That is, the communication path Ph includes the inner side of the inner wall of the communication groove 67h and the inner side of the inner wall of the upward extending portion 67e.

From the foregoing, the ceiling surface of the communication groove 67h, that is, the ceiling surface of the portion of the communication path Ph other than the upward extending portion 67e is located at a position lower than the lower end Lp of the opening of the communication path Ph on the outer peripheral surface side of the swiveling axial member 67, that is, the upper surface of the base plate 72. Therefore, when the atomized cutting fluid is floating in the machine interior space wS, the cutting fluid cf accumulates up to the ceiling surface in most of the communication path Ph. For this reason, the atomized cutting fluid floating in the machine interior space wS does not enter the internal space is from the communication path Ph together with the gas.

Although the gas in the through hole 67v is suctioned during the operation of the speed reducer 65, by ensuring that the through hole 67v has a sufficient length, the cutting fluid cf accumulated in the communication path Ph can be limited to rising only up to the intermediate portion of the through hole 67v.

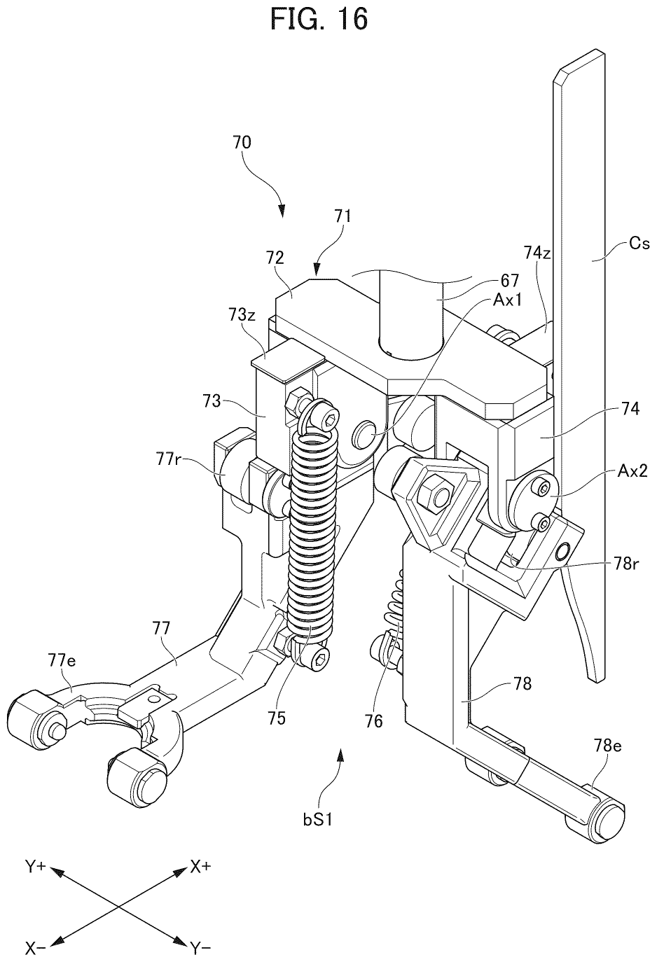

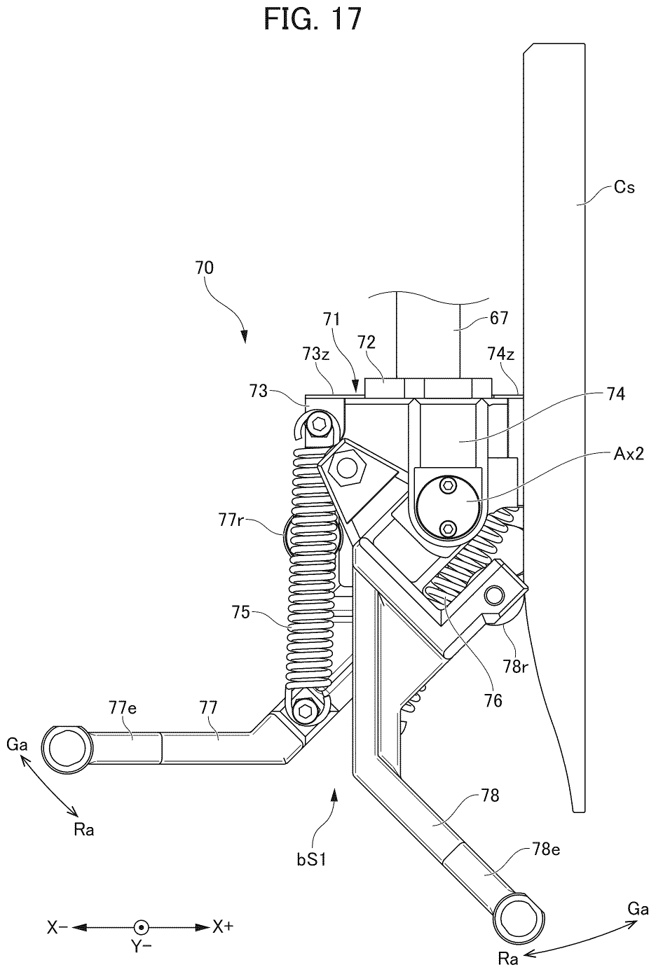

Next, the arm 70 shown in FIG. 2 will be described. As illustrated in FIG. 16, the arm 70 includes an arm base 71, a first gripping member 77, a second gripping member 78, a first biasing member 75, and a second biasing member 76. The arm base 71 includes a first base member 73 and a second base member 74 in addition to the base plate 72 described above.

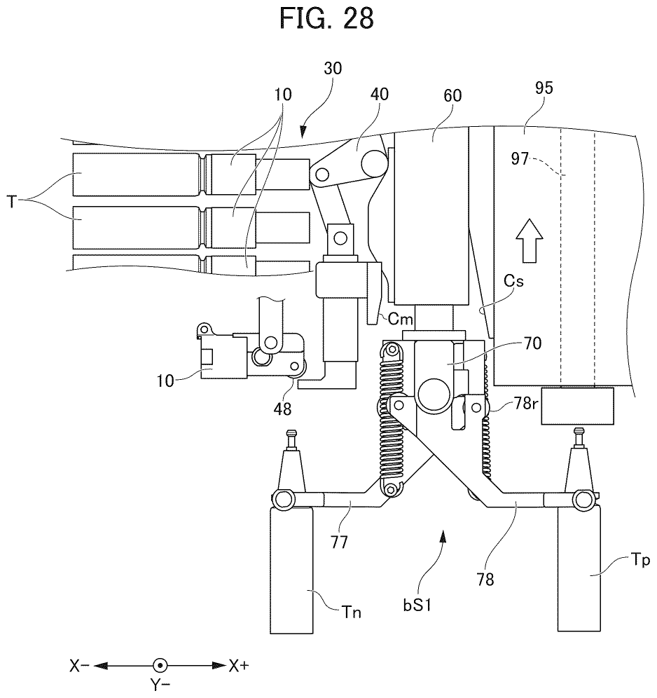

Hereinafter, as shown in FIG. 28, a state in which the arm 70 is at a predetermined rotating angle is referred to as a “first basic state bS1”, and as shown in FIG. 29, a state in which the arm is rotated by 180° about the up-down direction from the first basic state bS1 is referred to as a “second basic state bS2”. The arm 70 is configured as follows when viewed in the first basic state bS1 shown in FIG. 28.

As shown in FIG. 16, the first base member 73 is attached to a lower surface of a portion of the base plate 72 on the Y+ direction side. The second base member 74 is attached to a lower surface of a portion of the base plate 72 on the Y− direction side.

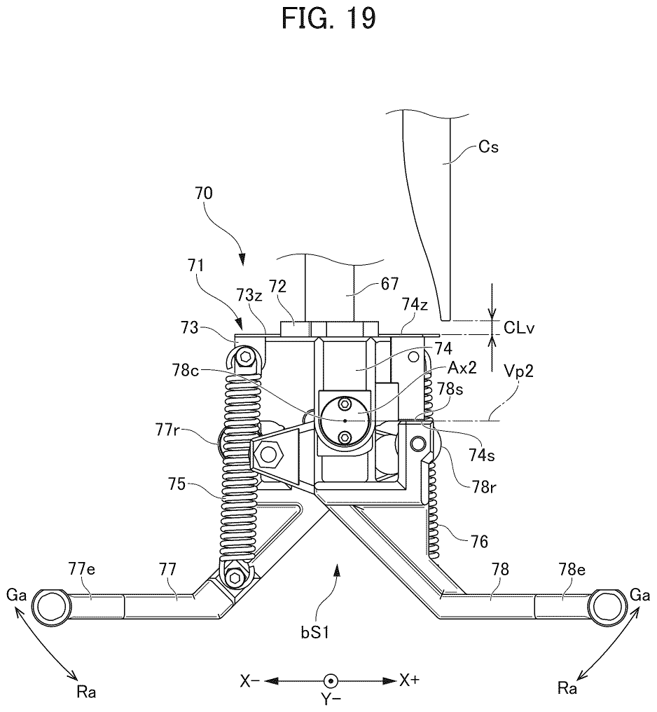

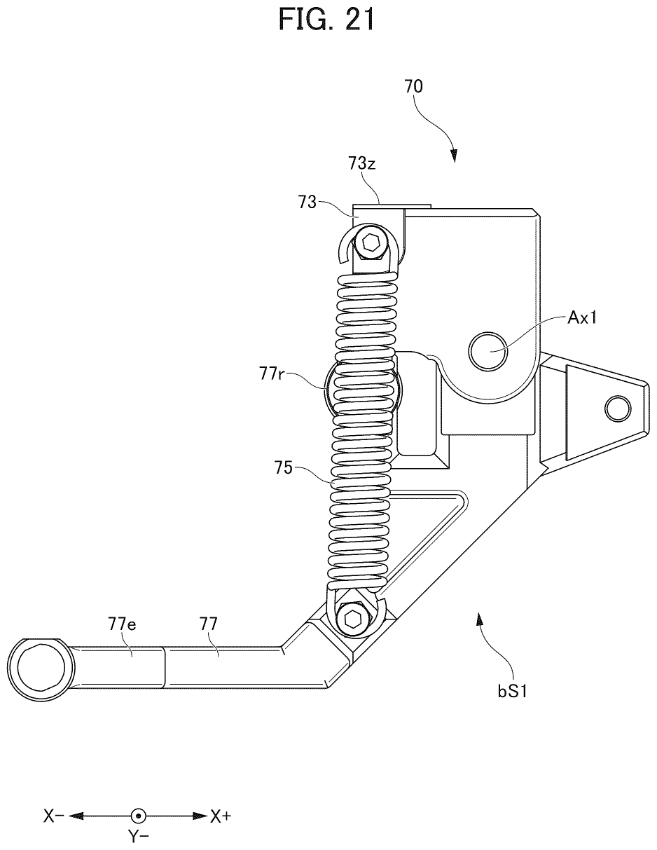

As shown in FIG. 21, the first gripping member 77 has a bent line shape extending downward, and then toward the X− direction side. As shown in FIG. 19, the second gripping member 78 has a bent line shape extending downward, and then toward the X+ direction side. As shown in FIG. 16, the upper end portion of the first gripping member 77 is attached to the first base member 73 by a first axial member Ax1 extending in the Y direction so as to be rotatable about the Y direction. The upper end portion of the second gripping member 78 is attached to the second base member 74 by a second axial member Ax2 extending in the Y direction so as to be rotatable about the Y direction. With such a configuration, the first gripping member 77 and the second gripping member 78 are attached to the arm base 71.

As shown in FIG. 16, a first gripping portion 77e is provided at the tip of the first gripping member 77. A second gripping portion 78e is provided at the tip of the second gripping member 78. Hereinafter, the first gripping member 77 and the second gripping member 78 will be collectively referred to as “gripping members 77 and 78”. The first gripping portion 77e and the second gripping portion 78e are collectively referred to as “gripping portions 77e and 78e”.

Each of the gripping portions 77e and 78e has a U-shape that opens toward the tip side, and is configured to be capable of gripping a portion of the upper portion of the tool T below the pull stud bolt pB.

As illustrated in FIG. 19, each of the gripping members 77 and 78 is displaced to a gripping angle Ga for gripping the tool T and a release angle Ra for releasing the gripping of the tool T by rotation about the Y direction as an axis. Both the first biasing member 75 and the second biasing member 76 are tension springs. One end portion of the first biasing member 75 is attached to the first gripping member 77, and the other end portion thereof is attached to the first base member 73. One end portion of the second biasing member 76 is attached to the second gripping member 78, and the other end portion thereof is attached to the second base member 74. The first biasing member 75 biases the first gripping member 77 toward the gripping angle Ga. The second biasing member 76 biases the second gripping member 78 toward the gripping angle Ga.

As shown in FIG. 16, a first roller 77r is attached to the first gripping member 77. A second roller 78r is attached to the second gripping member 78. As shown in FIG. 3, a magazine-side cam Cm is provided on the X− direction side of the arm 70. Specifically, the magazine-side cam Cm is attached to a frame, a housing, or the like of the tool changer 80. A spindle-side cam Cs is provided on the X+ direction side of the arm 70. Specifically, the spindle-side cam Cs is attached to the frame of the spindle assembly 95, the housing 96, and the like, and moves up and down together with the spindle assembly 95. The “spindle-side cam Cs” may also be referred to as a “pressing member”.

As shown in FIG. 3, in a state in which the arm 70 is raised from the arm lowest point by a certain extent or more, the first roller 77r comes into contact with the magazine-side cam Cm, and the second roller 78r comes into contact with the spindle-side cam Cs. At this time, the first roller 77r is biased toward the magazine-side cam Cm by the first biasing member 75, and the second roller 78r is biased toward the spindle-side cam Cs by the second biasing member 76. Thus, when the arm 70 is raised to a certain extent or more, the first gripping member 77 and the second gripping member 78 rotate following the profiles of the magazine-side cam Cm and the spindle-side cam Cs.

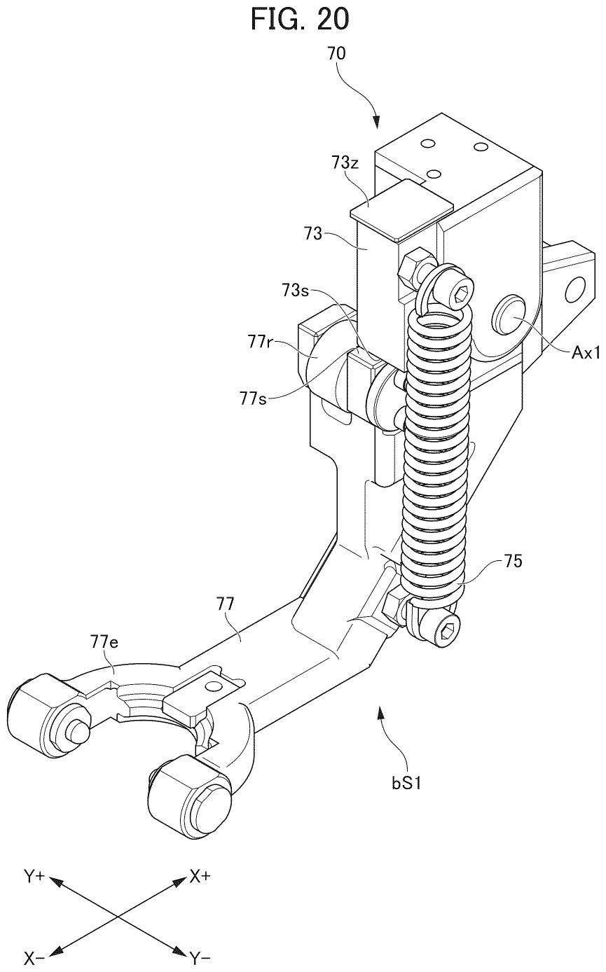

As shown in FIG. 20, a lower surface of an end portion of the first base member 73 on the X− direction side constitutes a first abutting surface 73s. The first abutting surface 73s restricts the range of rotation of the first gripping member 77 toward the gripping angle Ga by coming into contact with the first gripping member 77 at a position that prevents rotation toward the gripping angle Ga. A first contact surface 77s that comes into contact with the first abutting surface 73s in parallel from below is provided at an upper portion of the first gripping member 77.

As shown in FIG. 19, a lower surface of an end portion of the second base member 74 on the X+ direction side constitutes a second abutting surface 74s. The second abutting surface 74s restricts the range of rotation of the second gripping member 78 toward the gripping angle Ga by coming into contact with the second gripping member 78 at a position that prevents rotation toward the gripping angle Ga. A second contact surface 78s that comes into contact with the second abutting surface 74s in parallel from below is provided at an upper portion of the second gripping member 78.

As described above, the above description refers to the case where the arm 70 is viewed in the first basic state bs1. The description of the case where the arm 70 is viewed in the second basic state bS2 is the same as the above description in the case where “first” and “second” are replaced with each other and the reference numerals are replaced with the corresponding reference numerals.

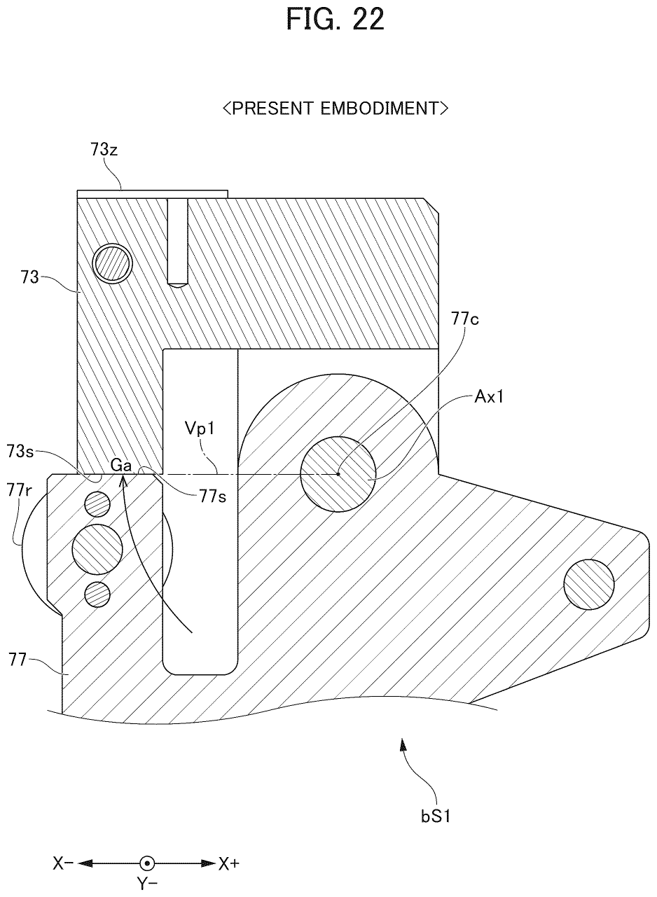

Next, a first problem to be solved in the arm 70 of the present embodiment will be described. The first gripping member 77 shown in FIG. 22 repeats the rotation toward the gripping angle Ga and the rotation toward the release angle Ra, thereby repeating the collision with the first abutting surface 73s. At the time of the collision, if the first gripping member 77 slides relative to the first abutting surface 73s, wear of the first abutting surface 73s and the first gripping member 77 progresses, and malfunction of the arm 70 may occur. Similarly, if the second gripping member 78 slides relative to the second abutting surface 74s, wear of the second abutting surface 74s and the second gripping member 78 progresses, and malfunction of the arm 70 may occur.

In order to solve the above problems, as shown in FIG. 22, on a first virtual plane Vp1 which includes the entire rotation axis 77c of the first gripping member 77, that is, the entire center line of the first axial member Ax1, the first abutting surface 73s extends along this first virtual plane Vp1. For this reason, the tangential direction of the rotation direction of the first gripping member 77 on the first abutting surface 73s inevitably faces the direction perpendicular to the surface of the first abutting surface 73s. Therefore, it is possible to suppress the generation of a force that causes the first gripping member 77 to shift parallel to the first abutting surface 73s.

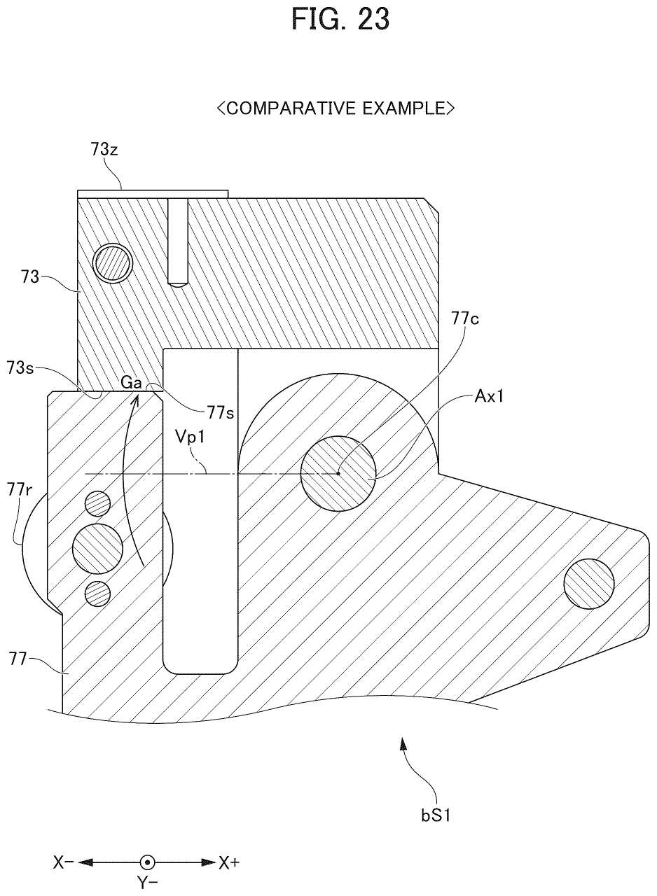

On the other hand, as in the comparative example shown in FIG. 23, when the first abutting surface 73s is offset from the first virtual plane Vp1, the tangential direction of the rotation direction of the first gripping member 77 on the first abutting surface 73s is tilted with respect to the perpendicular direction of the first abutting surface 73s. Therefore, a force that causes the first gripping member 77 to shift parallel to the first abutting surface 73s is easily applied.

From the above difference, according to the present embodiment, it is possible to suppress sliding when the first gripping member 77 collides with the first abutting surface 73s.

As shown in FIG. 19, the second abutting surface 74s extends along the second virtual plane Vp2 on this second virtual plane Vp2 which includes the entire rotation axis 78c of the second gripping member 78, that is, the entire center line of the second axial member Ax2. Therefore, for the same reason as in the case of the first abutting surface 73s, it is possible to suppress sliding when the second gripping member 78 collides with the second abutting surface 74s.

Next, a second problem to be solved in the arm 70 of the present embodiment will be described. When the machine tool 90 illustrated in FIG. 2 undergoes emergency-stop or the power supply of the machine tool 90 is turned OFF, the power supply of the arm swiveling device 60 is also normally turned OFF. In this case, the arm 70 is released from being held at the current rotation phase by the arm swiveling device 60. Therefore, as shown in FIG. 16, when the power of the arm swiveling device 60 is turned OFF in a state where the spindle-side cam Cs presses the second gripping member 78 or in a state where the spindle-side cam Cs presses the first gripping member 77, the arm 70 rotates by the pressing force.

Therefore, when the machine tool 90 is operated again thereafter, the arm 70 deviates from the original rotation phase. Therefore, it is necessary to restore the arm 70 to the original rotation phase, and the restoration operation takes time and effort. On the other hand, if a brake or the like is provided in the arm swiveling device 60 in order to prevent such a problem, control becomes complicated in addition to a cost increase.

In order to solve the above problems, the arm 70 is configured as follows when viewed in the first basic state bs1 shown in FIG. 16. A plate-shaped first rotation stopper member 73z protruding from the first base member 73 toward the Y+ direction side is provided at a portion on the X− direction side of the upper surface of the first base member 73. In addition, a plate-shaped second rotation stopper member 74z protruding from the second base member 74 toward the Y− direction side is provided at a portion on the X+ direction side on the upper surface of the second base member 74. Hereinafter, the first rotation stopper member 73z and the second rotation stopper member 74z are collectively referred to as “rotation stopper members 73z and 74z”.

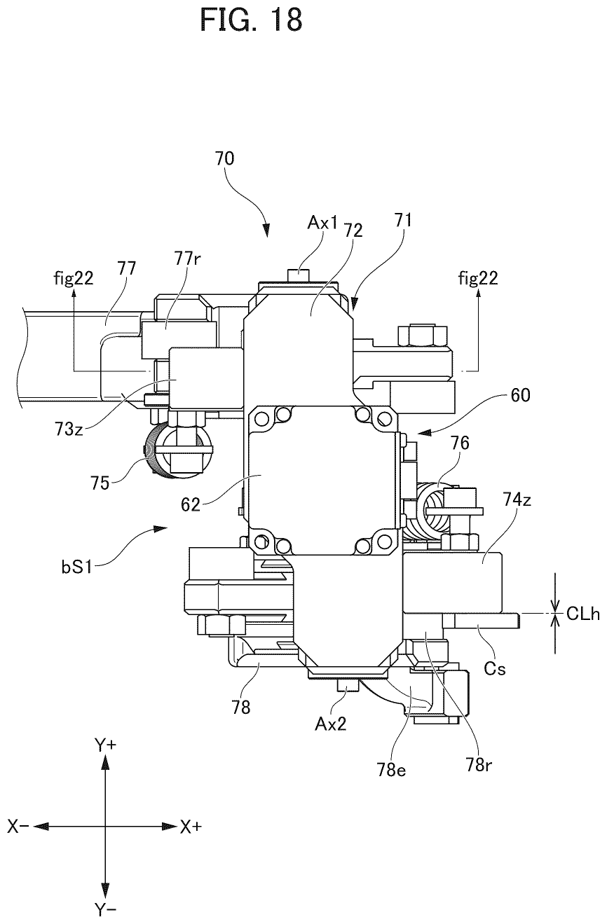

In a state in which the power of the arm swiveling device 60 is ON, as shown in FIG. 16, in a state in which the arm 70 is raised from the arm lowest point to a certain extent or more, as shown in FIG. 18, the second rotation stopper member 74z is provided on the Y+ direction side of the spindle-side cam Cs with a slight clearance CLh. The second rotation stopper member 74z restricts rotation of the arm 70 when the power of the arm swiveling device 60 is turned OFF.

That is, in a state where the power of the arm swiveling device 60 is ON and the arm 70 is held by the arm swiveling device 60 and does not rotate, as shown in FIG. 16, when the second gripping member 78 is pressed by the spindle-side cam Cs, the clearance CLh is provided between the second rotation stopper member 74z and the spindle-side cam Cs. On the other hand, when the power supply of the arm swiveling device 60 is turned OFF and the arm 70 attempts to rotate about the up-down direction as a result of the pressing of the second gripping member 78 by the spindle-side cam Cs, the second rotation stopper member 74z stops the rotation by coming into contact with the arm 70 at a position preventing the rotation by the pressing.

As described above, the above description refers to the case where the arm 70 is viewed in the first basic state bS1. The description of the case where the arm 70 is viewed in the second basic state bS2 is the same as the above description in the case where the “first” and the “second” are replaced with each other and the reference numerals are replaced with the corresponding reference numerals.

That is, in a state where the power supply of the arm swiveling device 60 is ON and the arm 70 is held by the arm swiveling device 60 and does not rotate, as shown in FIG. 31, when the spindle-side cam Cs presses the first gripping member 77, a clearance is provided between the first rotation stopper member 73z and the spindle-side cam Cs. On the other hand, when the power supply of the arm swiveling device 60 is turned OFF and the arm 70 attempts to rotate about the up-down direction as a result of the pressing of the first gripping member 77 by the spindle-side cam Cs, the first rotation stopper member 73z stops the rotation by coming into contact with the arm 70 at a position preventing the rotation by the pressing.

As shown in FIG. 19, when the arm swiveling device 60 rotates the base plate 72, a clearance CLv is provided between the rotation stopper members 73z and 74z, and the spindle-side cam Cs. That is, the rotation stopper members 73z and 74z are provided at positions where they do not come into contact with the spindle-side cam Cs.

Next, the control device 51 shown in FIG. 2 will be described. The control device 51 controls each driving device including the magazine swiveling device 39, the arm swiveling device 60, and the arm elevating device 55. Hereinafter, a specific procedure of tool replacement based on control by the control device 51 will be described.

As shown in FIG. 24, in the initial state, the arm 70 is located at the arm uppermost point. At this time, the arm 70 may be in the first basic state bS1 or in the second basic state bS2. Hereinafter, a case where the arm 70 is in the first basic state bS1 in the initial state will be described.

As shown in FIG. 24, in the initial state, the tool pot 10 at the replacement position ep is provided at the storage angle Sa following the profile of the pot drive cam 41. Further, the first gripping member 77 is provided at the release angle Ra following the profile of the magazine-side cam Cm, and the second gripping member 78 is also provided at the release angle Ra following the profile of the spindle-side cam Cs.

From this state, as shown in FIGS. 25 to 28, the arm 70 is lowered by the arm elevating device 55, and the spindle assembly 95 is raised. At this time, the tool pot 10 at the replacement position ep rotates to the replacement angle Ea following the profile of the pot drive cam 41 as shown in FIG. 26, and then rotates to the storage angle Sa again as shown in FIG. 27.

Further, as shown in FIG. 26, the first gripping member 77 rotates to the gripping angle Ga following the profile of the magazine-side cam Cm, and grips the subsequently-used tool Tn of the tool pot 10 at the replacement angle Ea. From this state, as shown in FIG. 27, the first gripping member 77 is lowered to remove the subsequently-used tool In from the tool pot 10.

Further, as shown in FIG. 27, the second gripping member 78 rotates toward the gripping angle Ga in accordance with the profile of the spindle-side cam Cs, and grips the previously-used tool Tp of the spindle 97. From this state, as shown in FIG. 28, the second gripping member 78 is lowered relative to the spindle 97 to remove the previously-used tool Tp from the spindle 97.

Next, as shown in FIG. 29, the arm 70 is rotated by 180° about the up-down direction by the arm swiveling device 60. By the rotation, the first basic state bS1 is changed to the second basic state bS2. As a result, the second gripping member 78 and the previously-used tool Tp are located on the X− side, and the first gripping member 77 and the subsequently-used tool In are located on the X+ side.

From this state, as shown in FIGS. 30 to 33, the spindle assembly 95 is lowered, and the arm 70 is raised by the arm elevating device 55. At this time, as shown in FIG. 30, the first gripping member 77 is raised relative to the spindle assembly 95 and the subsequently-used tool In is attached to the spindle 97. From this state, as shown in FIG. 31, the first gripping member rotates toward the release angle Ra following the profile of the spindle-side cam Cs to release the gripping of the subsequently-used tool Tn.

Further, the tool pot 10 at the replacement position ep rotates to the replacement angle Ea following the profile of the pot drive cam 41 as shown in FIG. 31, and then rotates to the storage angle Sa again as shown in FIGS. 32 and 33.

Further, the second gripping member 78 is raised as shown in FIG. 31, and the previously-used tool Tp is attached to the tool pot 10 at the replacement angle Ea. From this state, as shown in FIG. 32, the second gripping member 78 rotates toward the release angle Ra following the profile of the magazine-side cam Cm, and releases the gripping of the previously-used tool Tp.

As described above, the above description refers to the case where the initial state is the first basic state bS1. The description of the case where the initial state is the second basic state bs2 is the same as the above description in the case where the “first” and the “second” are replaced with each other and the reference numerals are replaced with the corresponding reference numerals.

Hereinafter, the configuration and advantageous effects of the present embodiment will be summarized.

As shown in FIG. 4, the fixing member 34 is fixed to the swivel member 35 and extends in the swiveling direction. In the fixing member 34, a corresponding support portion 344 is provided for each tool pot 10 such that the plurality of support portions 344 are arranged in the swiveling direction side by side. A corresponding biasing member 31 is provided for each tool pot 10. Each biasing member 31 is attached to a corresponding one of the tool pots 10 and a corresponding one of the support portions 344, and biases the corresponding tool pot toward the storage angle Sa. Therefore, the plurality of biasing members 31 can be supported by the swivel member 35 by one fixing member 34. Therefore, it is possible to support the plurality of biasing members 31 to the swivel member 35 without providing a corresponding support member for supporting the biasing members 31 to the magazine base 38 for each tool pot 10. As a result, it is possible to reduce the number of assembly steps of the tool magazine 30, and it is possible to reduce the manufacturing cost.

The biasing members 31 are tension springs. Each of the support portions 344 has a key shape engageable with an end portion of a corresponding biasing member 31. Therefore, it is possible to achieve the fixing member 34 having a simple shape.

The fixing member 34 has an annular shape that makes one revolution in the swiveling direction of the swivel member 35. Therefore, for example, it is possible to efficiently secure the strength of the fixing member 34 as compared with a case where the fixing member 34 has a C-shape or the like.

The fixing member 34 is made of metal. Therefore, in this respect as well, it is possible to efficiently secure the strength of the fixing member 34.

As shown in FIG. 7, the clamp mechanism 12 is attached to the clamp attachment hole 18h. The posture holding member 13 is inserted into the insertion hole 18v and holds the posture of the clamp mechanism 12 relative to the pot body 18. Therefore, it is possible to hold the posture of the clamp mechanism 12 relative to the pot body 18 without using a screw or the like. Therefore, it is possible to select a material which is difficult to be screw-fixed in terms of strength as the material of the pot body 18, and it is possible to simplify the structure of the pot body 18. This leads to reductions in weight, size, and cost of the tool pot 10.

Further, the posture holding member 13 includes the insertion through hole 13v through which the pull stud bolt pB passes to the clamp mechanism 12 when the pull stud bolt pB is inserted into the insertion hole 18v. Therefore, the posture holding member 13 does not prevent the pull stud bolt pB from passing therethrough, and the contour of the posture holding member 13 is inevitably larger than the contour of the pull stud bolt pB. This makes it possible to sufficiently increase the size of the posture holding member 13 in a limited space such as the pot body 18. As a result, it is possible to sufficiently hold the posture of the clamp mechanism 12 relative to the pot body 18 firmly.

As described above, it is possible to sufficiently hold the posture of the clamp mechanism 12 relative to the pot body 18 firmly while reducing the weight, size, and cost of the tool pot 10.

As shown in FIG. 7, the protrusion 131 protruding toward the clamp mechanism 12 is provided at a portion of the posture holding member 13 adjacent to the insertion through hole 13v. As shown in FIG. 10, the protrusion 131 engages with the clamp mechanism 12 to hold the posture of the clamp mechanism 12 relative to the pot body 18. This makes it possible to hold the posture of the clamp mechanism 12 in a simple configuration.

As shown in FIG. 10, the insertion through hole 13v has a tapered shape having a decreasing diameter as approaching the clamp mechanism 12. Therefore, it is possible to guide the pull stud bolt pB to the clamp mechanism 12 by the insertion through hole 13v.

The pot body 18 shown in FIG. 10 is made of resin. This makes it possible to reduce the weight, size, and cost of the tool pot 10. On the other hand, the clamp mechanism 12 and the posture holding member 13 are made of metal. This makes it possible to sufficiently secure the strength of the clamp mechanism 12 that actually holds the tool and the strength of the posture holding member 13 that holds the posture of the tool.

As shown in FIG. 10, the posture holding member 13 holds the posture of the clamp mechanism 12 relative to the pot body 18 by engaging with the clamp base 122 in which the pair of contact members 127 and the pair of biasing members 126 are housed. This makes it possible to hold the posture of the clamp mechanism 12 in a simple configuration.

As shown in FIG. 13, the swiveling axial member 67 is provided with the through hole 67v extending in the up-down direction and having an upper end portion communicating with the internal space iS. The base plate 72 is attached to the lower end portion of the swiveling axial member 67. The communication path Ph is provided between the swiveling axial member 67 and the base plate 72 to allow the lower end portion of the through hole 67v and the outer side of the outer peripheral surface of the swiveling axial member 67 to communicate with each other. Therefore, even in the case that the cutting fluid enters and accumulates in the internal space is, it is possible to discharge the cutting fluid to the machine interior space wS through the through hole 67v and the communication path Ph.

Moreover, as shown in FIG. 15, the ceiling surface of the communication groove 67h, that is, the ceiling surface of a portion of the communication path Ph other than the upward extending portion 67e, is located at a position lower than the lower end Lp of the opening of the communication path Ph on the outer peripheral surface of the swiveling axial member 67. Therefore, in the case that the atomized cutting fluid floats in the machine interior space wS, the cutting fluid cf accumulates up to the ceiling surface in most of the communication path Ph. For this reason, the atomized cutting fluid floating in the machine interior space wS will not enter the internal space is from the communication path Ph together with the gas.

As described above, it is both possible to suppress the atomized cutting fluid floating in the machine interior space wS from entering the internal space is together with the gas, and to make it difficult for the cutting fluid to accumulate in the internal space is.

As shown in FIG. 22, on the first virtual plane Vp1 which includes the entire rotation axis 77c of the first gripping member 77, that is, the entire center line of the first axial member Ax1, the first abutting surface 73s extends along this first virtual plane Vp1. For this reason, the tangential direction of the rotation direction of the first gripping member 77 on the first abutting surface 73s inevitably faces the direction perpendicular to the surface of the first abutting surface 73s. Therefore, it is possible to suppress sliding when the first gripping member 77 collides with the first abutting surface 73s. In addition, similarly to this, it is possible to suppress sliding when the second gripping member 78 collides with the second abutting surface 74s.

In addition, the first gripping member 77 includes the first contact surface 77s that comes into contact with the first abutting surface 73s in a parallel manner. Therefore, for example, as compared with a case where a roller or the like of the first gripping member 77 is in line contact with the first abutting surface 73s, the contact area of the first gripping member 77 with respect to the first abutting surface 73s can be increased, such that it is possible to reduce wear between the first abutting surface 73s and the first gripping member 77. In addition, the second gripping member 78 includes the second contact surface 78s that comes into contact with the second abutting surface 74s in a parallel manner. Therefore, it is possible to reduce wear between the second abutting surface 74s and the second gripping member 78 for the same reason as described above.

As shown in FIG. 16, the arm 70 is provided with the first rotation stopper member 73z and the second rotation stopper member 74z. When the arm 70 attempts to rotate by the pressing of the second gripping member 78 by the spindle-side cam Cs, the rotation is stopped by the second rotation stopper member 74z coming into contact with the spindle-side cam Cs at a position preventing the rotation by the pressing. Further, when the arm 70 attempts to rotate by the pressing of the first gripping member 77 by the spindle-side cam Cs shown in FIG. 31, the first rotation stopper member 73z stops the rotation by coming into contact with the spindle-side cam Cs at a position preventing the rotation by the pressing. Therefore, even when the power of the arm swiveling device 60 is turned OFF in a state where the gripping members 77 and 78 are pressed by the spindle-side cam Cs, the arm 70 can be prevented from rotating by the pressing by the first rotation stopper member 73z or the second rotation stopper member 74z.

When the second gripping member 78 is pressed by the spindle-side cam Cs in a state in which the power of the arm swiveling device 60 shown in FIG. 18 is ON and the base plate 72 is held by the arm swiveling device 60 and does not rotate, a clearance CLh is provided between the second rotation stopper member 74z and the spindle-side cam Cs. Similarly, when the first gripping member 77 is pressed by the spindle-side cam Cs in the non-rotating state as shown in FIG. 31, a clearance is provided between the first rotation stopper member 73z and the spindle-side cam Cs. Therefore, in a state where the power supply of the arm swiveling device 60 is ON, there is no concern that the first rotation stopper member 73z or the second rotation stopper member 74z will come into sliding contact with the spindle-side cam Cs to generate frictional resistance or wear.

As shown in FIG. 19, when the base plate 72 is rotated by the arm swiveling device 60, the rotation stopper members 73z and 74z are provided at positions not in contact with the spindle-side cam Cs. Therefore, when the base plate 72 is rotated, there is no concern that the first rotation stopper member 73z and the second rotation stopper member 74z will come into sliding contact with the lower end portion of the spindle-side cam Cs to generate frictional resistance and wear.

### Second Embodiment

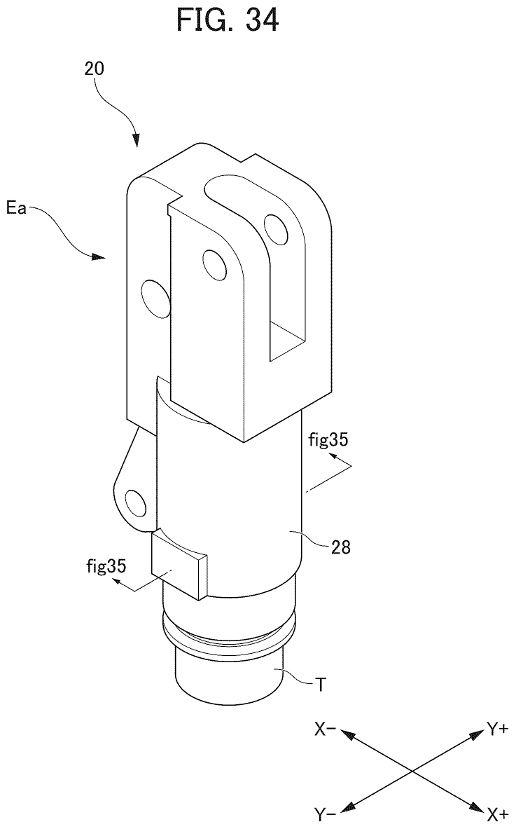

Next, a second embodiment will be described with reference to FIGS. 34 to 40. Note that the present embodiment will be described based on the first embodiment with a focus on differences from the first embodiment, and descriptions of the same or similar points as those of the first embodiment will be omitted as appropriate.

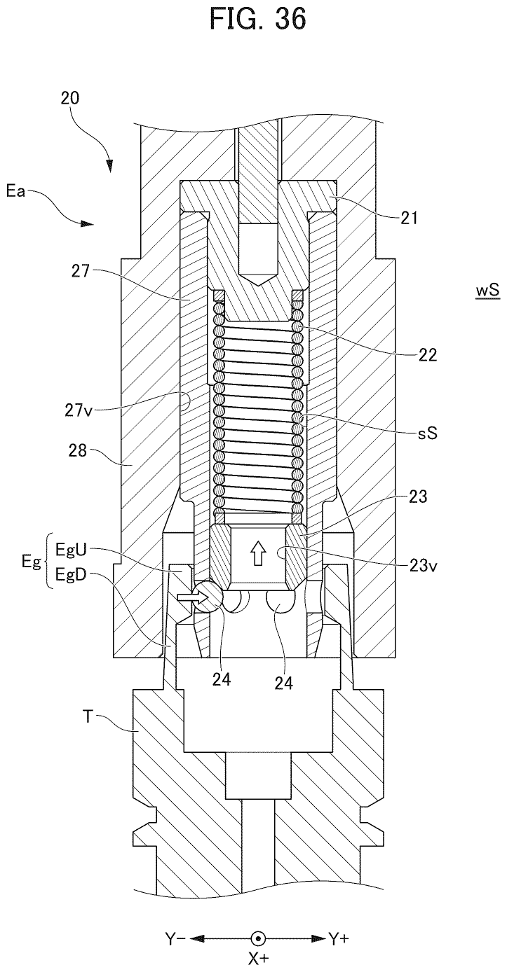

The present embodiment is different from the first embodiment in that the magazine 30 shown in FIG. 4 includes a plurality of tool pots 20 shown in FIG. 34 instead of the plurality of tool pots 10. In FIG. 34, the pot rollers are not shown. As shown in FIG. 36, the base end portion of each tool T is different in that an engagement portion Eg is provided instead of the pull stud bolt pB. The engagement portion Eg includes an upper portion EgU and a lower portion EgD. The upper portion EgU protrudes further toward the inner peripheral side of the tool T than the lower portion EgD. The engagement portion Eg may be referred to as the “end portion of the tool”.

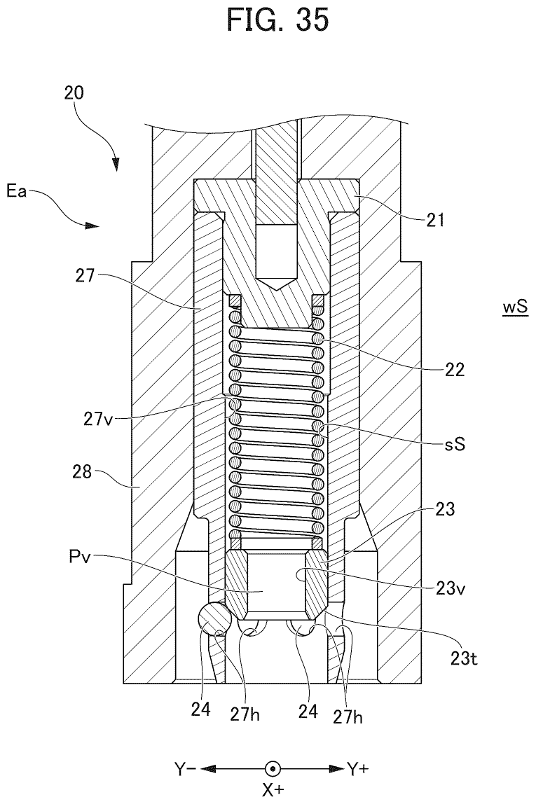

As shown in FIG. 35, the tool pot 20 includes a pot body 28, a cylindrical member 27, a biasing member 22, a piece 23, and a plurality of contact members 24. The pot body 28 is made of resin. The cylindrical member 27 is made of metal. The biasing member 22 is a metal pressing spring. The piece 23 is made of metal. Each of the contact members 24 is a metal ball.

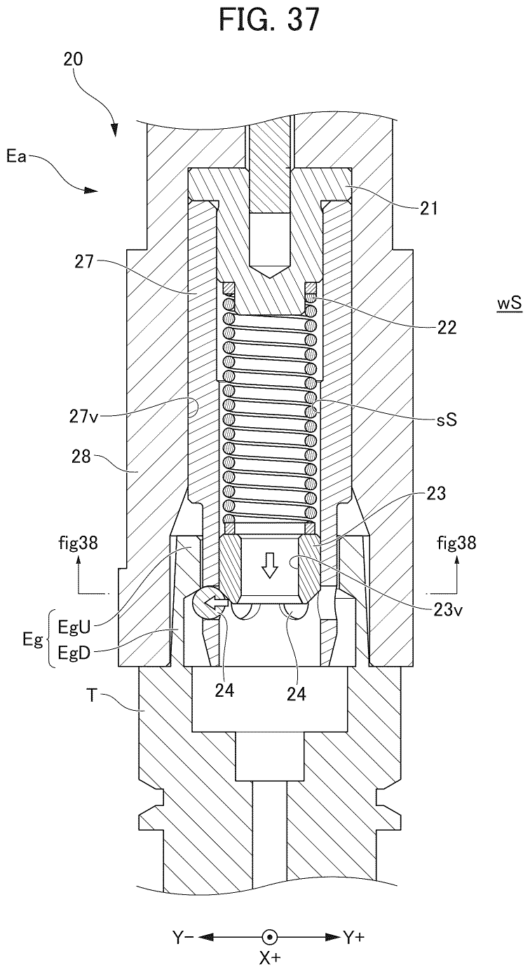

The tool pot 20 is configured as follows in the state shown in FIG. 35, that is, in a state in which the tool pot 20 is provided at the replacement angle Ea at the replacement The pot body 28 has a cylindrical shape that opens downward, and is configured so that the engagement portion Eg of the tool T is insertable from below, as shown in FIGS. 36 and 37. Therefore, the “upward” referred to below may be referred to as the “insertion direction of the tool T”, and the “downward” referred to below may be referred to as the “opposite insertion direction of the tool T”.

As shown in FIG. 35, the cylindrical member 27 is fixed to the inside of the pot body 28 so that the axial direction thereof faces the up-down direction. The piece 23 is provided inside the lower end portion of the cylindrical member 27 so as to be displaceable in the up-down direction. Hereinafter, the space above the piece 23 inside the cylindrical member 27 is referred to as a “storage space sS”. The biasing member 22 is stored in the storage space sS. A retainer 21 for holding the upper end portion of the biasing member 22 is attached to the upper end portion of the cylindrical member 27. Therefore, the biasing member 22 is interposed between the retainer 21 and the piece 23, and biases the piece 23 downward.

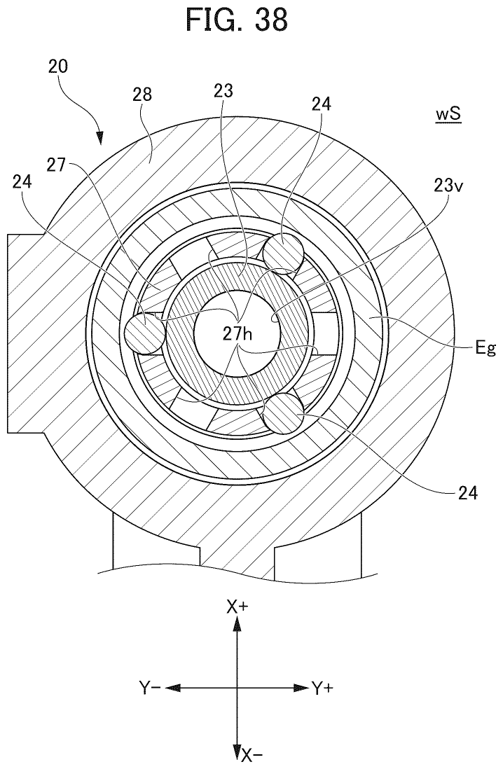

A plurality of attachment holes 27h are each provided so as to penetrate through a lower end portion of the cylindrical member 27. The plurality of attachment holes 27h extend radially in the radial direction of the cylindrical member 27 in a bottom view shown in FIG. 38. Each of the contact members 24 is attached to any of the plurality of attachment holes 27h. Therefore, each of the contact members 24 is configured to be able to protrude outward from the outer peripheral portion of the cylindrical member 27 and to be able to retract inward. In the drawings, the number of the contact members 24 is three, but may be two or less or four or more.

As shown in FIG. 35, the piece 23 has a tapered surface 23t at the lower end portion. Therefore, as the piece 23 is displaced downward, the plurality of contact members 24 are pressed by the tapered surface 23t and protrude outward from the outer peripheral portion of the lower end portion of the cylindrical member 27.

As shown in FIG. 36, when the engagement portion Eg of the tool T is inserted into the clamp hole 122v, the plurality of contact members 24 are temporarily pushed inward by the upper portion EgU of the engagement portion Eg. When the plurality of contact members 24 press the tapered surface 23t, the piece 23 is pushed up against the biasing force of the biasing member 22. Thereafter, as shown in FIG. 37, when the upper portion EgU of the engagement portion Eg passes through the positions of the plurality of contact members 24, the piece 23 is lowered by the biasing force of the biasing member 22, and the plurality of contact members 24 protrude outward again. The plurality of contact members 24 hold the engagement portion Eg. As described above, when the engagement portion Eg of the tool T is inserted into the tool pot 10, the engagement portion Eg is held by the plurality of contact members 24.

In the above description, the tool pot 20 is provided at the replacement angle Ea at the replacement position ep as described above.

Next, problems to be solved by the present embodiment will be described. As shown in FIGS. 36 and 37, when the tool pot 20 shown in FIG. 35 holds the engagement portion Eg of the tool T or releases the holding, the biasing member 22 expands and contracts. Thus, the storage space sS also repeats expansion and compression. Incidentally, there is a possibility that the coolant liquid used at the time of machining by the tool T is scattered as mist in the machine interior space wS in which the tool pot 20 is provided. Therefore, the coolant liquid in the machine interior space wS may enter the storage space ss due to repeated expansion and compression of the storage space sS. Since the storage space sS is surrounded by the cylindrical member 27 and the piece 23, a part of the coolant liquid that has entered is likely to remain in the storage space sS. Therefore, the coolant liquid may continue to remain in the storage space ss for a long period of time, and corrosion of the cylindrical member 27, the biasing member 22, and the piece 23 may progress. The corrosion may lead to a defect in the holding operation of the tool T by the tool pot 20.

In order to solve this problem, a communication path Pv is provided in the piece 23, as shown in FIG. 35. The communication path Pv is configured as follows in a state where the tool pot 20 is provided at the replacement angle Ea at the replacement position ep.

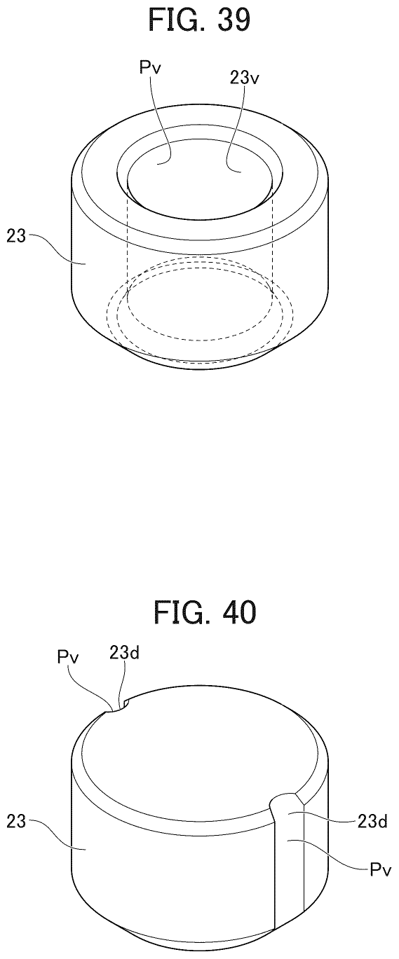

The communication path Pv extends from the upper end to the lower end of the piece 23 to communicate between the storage space ss and the outside thereof. Specifically, in the present embodiment, a communication hole 23v is provided as the communication path Pv as shown in FIG. 39. The communication hole 23v penetrates the piece 23 in the up-down direction. However, instead of this or in addition thereto, communication grooves 23d may be provided as communication paths Pv as shown in FIG. 40. The communication grooves 23d are each recessed on the outer peripheral surface of the piece 23 and each extend in the up-down direction. In the above description, the tool pot 20 is provided at the replacement angle Ea at the replacement position ep as described above.

According to the present embodiment, when the coolant liquid or the like enters the storage space sS from the machine interior space wS shown in FIG. 35, the coolant liquid is discharged from the communication path Pv. This makes it possible to achieve the tool pot 20 in which the coolant liquid is easily discharged from the storage space ss, even if the coolant liquid enters the storage space sS. This makes it possible to suppress corrosion of the biasing member 22, the piece 23, and the cylindrical member 27.

### Other Embodiments

The embodiment described above can be modified as follows, for example. The arm 70 shown in FIG. 16 may include three or more gripping members instead of two gripping members 77 and 78. When there are three gripping members, for example, the arm swiveling device 60 shown in FIG. 2 may rotate the arm 70 by 120° instead of 180°.

According to the above embodiments, it is possible to achieve the tool changing arm (70) of Additional Remarks 1 and 2 described below.

### [Additional Remark 1]

A tool changing arm (70) in a tool (T) changer including the tool changing arm (70) and causing the tool changing arm (70) to replace the tool (T) used by a machine tool (90), the tool changing arm (70) including: an arm base (71); a plurality of gripping members (77, 78) rotatably attached to the arm base (71) and each configured to grip and release the tool (T) by rotation; and a biasing member (75, 76) that biases the plurality of gripping members (77, 78) in a predetermined rotation direction as one of the rotation directions,
wherein the plurality of gripping members (77, 78) are configured to rotate in a direction opposite to the predetermined rotation direction against the biasing force of the biasing member (75, 76) when the plurality of gripping members (77, 78) are pressed by the pressing member (Cs),
wherein an abutting surface (73s, 74s) that limits a rotation range of one of the plurality of gripping members (77, 78) by the abutting surface (73s, 74s) coming into contact with the one of the plurality of gripping members (77, 78) at a position that prevents the one of the plurality of gripping members (77, 78) from rotating is provided,
and wherein the abutting surface (73s, 74s) extends, on a virtual plane (Vp1, Vp2) including an entire rotation axis of one of the plurality of gripping members (77, 78), along the virtual plane (Vp1, Vp2).

### [Additional Remark 2]

In the tool changing arm (70) as described in Additional Remark 1, one of the plurality of gripping members (77, 78) includes a contact surface (77s, 78s) that comes into parallel contact with the abutting surface (73s, 74s).

### [Additional Remark 3]

The tool changing arm (70) as described in Additional Remark 1 or 2 further includes a biasing member (75, 76) that presses the one of the plurality of gripping members (77, 78) toward a side (Ga) of gripping the tool (T), in which, when the one of the plurality of gripping members (77, 78) is pressed by a pressing member (Cs) provided outside the tool changing arm (70), the one of the plurality of gripping members (77, 78) rotates to a side (Ra) of releasing the gripping of the tool (T) against the biasing force of the biasing member (75, 76), and the abutting surface (73s, 74s) restricts a rotation range of the one of the plurality of gripping members (77, 78) toward the side (Ga) of gripping the tool (T).

### EXPLANATION OF REFERENCE NUMERALS

70 arm (tool changing arm)
71 arm base
73s first abutting surface (abutting surface)
74s second abutting surface (abutting surface)
75 first biasing member (biasing member)
76 second biasing member (biasing member)
77 first gripping member (gripping member)
77s first contact surface (contact surface)
78 second gripping member (gripping member)
78s second contact surface (contact surface)
90 machine tool
Cs spindle-side cam (pressing member)
T tool
Ga gripping angle (side of gripping a tool)
Ra release angle (side of releasing the gripping of a tool)
Vp1 first virtual plane (virtual plane)
Vp2 second virtual plane (virtual plane)

What is claimed is:

1. A tool changing arm that replaces a tool used by a machine tool, the tool changing arm comprising:
an arm base; and
a plurality of gripping members rotatably attached to the arm base and each configured to grip and release the tool by rotation,
wherein the arm base includes an abutting surface that limits a rotation range of one of the plurality of gripping members by the abutting surface coming into contact with the one of the plurality of gripping members at a position that prevents the one of the plurality of gripping members from rotating, and
the abutting surface extends, on a virtual plane including an entire rotation axis of one of the plurality of gripping members, along the virtual plane.

2. The tool changing arm according to claim 1, wherein the one of the plurality of gripping members includes a contact surface that comes into parallel contact with the abutting surface.

3. The tool changing arm according to claim 1 further comprising a biasing member that presses the one of the plurality of gripping members toward a side of gripping the tool,
wherein, when the one of the plurality of gripping members is pressed by a pressing member provided outside the tool changing arm, the one of the plurality of gripping members rotates to a side of releasing the gripping of the tool against the biasing force of the biasing member, and
the abutting surface restricts a rotation range of the one of the plurality of gripping members toward the side of gripping the tool.
